(19) United States
(12) Patent Application Publication
(10) Pub. No.: US 2011/0033217 A1
(43) Pub. Date: Feb. 10, 2011

(54) Image Forming System and Post-Processing Apparatus

(75) Inventors: Utami Soma, Tokyo (JP); Satoshi Sakata, Tokyo (JP); Masanobu Kawano, Toyokawa-shi (JP); Kenji Yamamoto, Tokyo (JP); Kazumichi Yamauchi, Tokyo (JP); Hideki Nakamura, Tokyo (JP); Akira Okamoto, Tokyo (JP); Kazutoshi Yoshimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Business Technologies, Inc., Tokyo (JP)

(21) Appl. No.: 12/905,378

(22) Filed: Oct. 15, 2010

Related U.S. Application Data
(62) Division of application No. 11/403,896, filed on Apr. 14, 2006.

(30) Foreign Application Priority Data
Apr. 22, 2005 (JP) JP2005-124968
Jul. 4, 2005 (JP) JP2005-194729
Aug. 4, 2005 (JP) JP2005-226363
Feb. 8, 2006 (JP) JP2006-030549

(51) Int. Cl. G03G 15/00

(52) U.S. Cl. 399/405

(57) ABSTRACT

There is described an image forming system, which confirms a finished state of an image at any time during the implementation of the image forming job as needed. The system includes: an image forming section to respectively form images on recording materials; a stacking section to stack the recording materials continuously ejected from the image forming section; an instruction inputting section from which an operator inputs instruction information; an ejecting section to stack a part of the recording materials in such a manner that the operator can pick up stacked recording materials by hand; a controlling section to conduct controlling operations in response to the instruction information, inputted from the instruction inputting section during an implementation of an image forming job including an operation for stacking the recording materials ejected from the image forming section, in order to eject the part of the recording materials onto the ejecting section.

This application is based on Japanese Patent Applications NO. 2005-124968, NO. 2005-194729, NO. 2005-226363 and NO. 2006-030549, filed on Apr. 22, 2005, Jul. 4, 2005, Aug. 4, 2005 and Feb. 8, 2006, respectively, in Japanese Patent Office, the entire contents of which are hereby incorporated by reference.

### BACKGROUND OF THE INVENTION

The present invention relates to an image forming system that forms an image on a recording material and stacks the recording material, on which the image is formed, onto a stacking section, and a post-processing apparatus provided with the stacking section. Further, the present invention also relates to an image forming apparatus and an image forming system, which makes it possible to output a proofing image as a confirmation-image output.

Conventionally, there has been well known an image forming apparatus, such as a copier, printer, multi-functional printer etc., that makes a test print such as copy including either one sheet or plural sheets for confirming whether or not the desired image quality can be obtained on the final copy, prior to implementing an image forming job, and then, implements the image forming job after confirming the quality of the image formed on the test copy. For instance, Tokkaihei 8-106191 (Japanese Non-Examined Patent Publication: Patent Document 1) sets forth an image forming apparatus, which is provided with a test copy mode for checking the copy efficiency under the copy condition established, and ejects the test copy onto an ejecting section disposed at separate position of a normal ejecting tray.

Further, recently, the image forming apparatuses have been gradually introduced in the commercial printing field in which a large amount of copies should be outputted. Demands for such the image forming apparatus to be utilized in the commercial printing field include not only ability for continuously printing a large amount of copies, but also uniformity of finished quality among the large amount of copies produced in such the continuous printing operation, namely, ability for uniformly maintaining the image quality of the copies produced during the copy processing.

In image forming jobs for outputting a large amount of copies, however, sometimes it is impossible to maintain the finished quality confirmed in advance between the image forming jobs, since the density, the color appearance, etc. are liable to change, due to the environmental changes during the operation in the apparatus, such as humidity, etc., and the characteristics changes of the materials employed in the apparatus.

When conducting image recording operations for producing a large amount of copies, there is a possibility that the finished quality (output status) would change due to the aged deterioration of the image forming apparatus, the materials, etc. On the other hand, it is virtually impossible to confirm the finished quality in the mid course of the image forming job in which the image forming operation for a large amount of copies and the stacking operation of them are currently conducted. When a large amount of copies are to be outputted, a post-processing apparatus, such as a copy stacker, etc., is often coupled to the image forming apparatus, so as to stack the papers on which images are formed by the image forming apparatus onto the post-processing apparatus. During the image forming operation, the front door of the post-processing apparatus are locked in a closed state, so that the operator cannot touch the papers on which images are formed by the image forming apparatus, until the consecutive image forming job has been completed. Accordingly, even if the desired finished quality cannot be maintained due to the change of the image quality, etc. in the mid course of the image forming operation, the operator cannot recognize such the deficiency unless all of the copies are outputted, resulting in waist of the large amount of papers. To cope with this problem, it would be possible for the operator to confirm a status of the finished quality by deactivating the operation of the apparatus so as to stop the image forming job in the mid course of its operation. However, this has resulted in a deterioration of the productivity.

Further, conventionally, a capability of producing a large amount of printed products at a time and a capability of producing high quality output images are demanded for the image forming apparatus employed in the printing market, etc. Accordingly, if an deficiency is found after the large amount of printed products are outputted, a reprinting operation should be conducted after the correcting operation for the found deficiency is completed, resulting in a consumption of large amount of unnecessary papers and toner. To overcome this problem, there has been well known an image forming apparatus having a capability of implementing a proofing operation (outputting operation of a confirmation image) of an image forming job, etc.

As an example of the above, there has been well known an image forming apparatus that conducts the image forming operation after the confirmation image is outputted (for instance, the Patent Document 1). Further, there has been well known an image forming apparatus that allows to shifting to the output operation of the confirmation image before a start of a normal job and in a suspended term of a job (for instance, set forth in Patent Document 2: Tokkai 2000-35730 (Japanese Non-Examined Patent Publication). Still further, there has been well known an image forming apparatus that is capable of outputting a confirmation image for confirming a density of a part of document image, designated as a specific part to which a special attention should be given when copying the document image, for instance, the specific part is around four to five lines (for instance, set forth in Patent Document 3: Tokkai 2001-350373 (Japanese Non-Examined Patent Publication).

However, since the image forming apparatus, set forth in Patent Document 1, conducts the main copying operation (job output) after the output operation of the confirmation image is completed, there has been a problem that it is impossible to output the confirmation image during the implementation of the job output, and accordingly, the production of the copies could not be completed in time even if an urgent completion of the image forming operation is requested. Further, there has been another problem that a tray, onto which the confirmation images are ejected, has been provided separately form another tray on which the normal job images are ejected, resulting in a complexity of the configuration of the image forming apparatus.

Further, according to the image forming apparatus set forth in Patent Document 2, the output operation of the confirmation images is possible only before the commencement of the normal job or during an interval of suspending the job. Accordingly, since it is impossible to output the confirmation images during the implementation of the job output, there has been a problem that the production of the copies could not be completed in time even if an urgent completion of the image forming operation is requested.

Still further, the image forming apparatus set forth in Patent Document 3 is so constituted that the image finishing state of the specific area, at which the user intends to specifically confirm the density variation within a range of 1 page, can be confirmed by, for instance, designating an area around four to five lines from the top of 1 page concerned. There has been a problem, however, that it has been difficult to check the suitability of the image position relative to the paper sheet by selecting an arbitral page from plural job pages.

### SUMMARY OF THE INVENTION

It is a feature of the present invention to provide an image forming system, which makes it possible to confirm a finish status of the image at any time during the implementation of the image forming job as needed.

Further, it is another feature of the present invention to provide an image forming system, which makes it possible to complete an urgent production of the copies in time even if the confirmation image is requested to be outputted during the implementation of the image forming job, and to confirm the image position and the image quality without complicating the configuration of the system.

The present invention may comprise image forming systems described as follow.
(1) An image forming system, having: an image forming section to respectively form images on recording materials; a stacking section to stack recorded materials continuously ejected from the image forming section after the images are respectively formed on the recording materials; an instruction inputting section from which an operator inputs instruction information with respect to a confirmation-image outputting operation for confirming a finished status of the images formed on the recorded materials; an ejecting section to stack a part of the recorded materials ejected from the image forming section; a controlling section to conduct controlling operations in response to the instruction information, inputted from the instruction inputting section during an implementation of an image forming job including an operation for stacking the recorded materials ejected from the image forming section, in order to eject the part of the recorded materials onto the ejecting section.
(2) A post-processing apparatus, coupled to an image forming apparatus for respectively forming images onto recording materials and provided with a stacking section for stacking the recorded materials continuously ejected from the image forming apparatus after the images are respectively formed on the recording materials, having: an instruction inputting section from which an operator inputs instruction information with respect to a confirmation-image outputting operation for confirming a finished status of the images formed on the recording materials; an ejecting section to stack a part of the recorded materials ejected from the image forming apparatus; a controlling section to conduct controlling operations in response to the instruction information, inputted from the instruction inputting section during an implementation of an image forming job including an operation for stacking the recorded materials ejected from the image forming apparatus, in order to eject the part of the recorded materials onto the ejecting section.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a cross sectional view of a brief configuration of an image forming system embodied in the present invention as the first embodiment;

FIG. 2 shows a block diagram of a main controlling configuration of the image forming system shown in FIG. 1;

FIG. 3 shows a schematic diagram of a configuration of the main part of a post-processing apparatus shown in FIG. 1;

FIG. 4 shows a flowchart of a conveyance control processing to be implemented in a second control device shown in FIG. 2;

FIG. 5 shows an exemplified configuration of a high-speed image forming system embodied in the present invention as the second embodiment;

FIG. 6 shows a conceptual schematic diagram of a high-speed image forming apparatus shown in FIG. 5;

FIG. 7 shows a conceptual schematic diagram of a paper feeding apparatus shown in FIG. 5;

FIG. 8 shows a conceptual configuration of copy stackers ST1, ST2 shown in FIG. 5;

FIG. 9 shows a block diagram of a controlling configuration of a high-speed image forming system embodied in the present invention as the second embodiment;

FIG. 10 shows a flowchart of a test copy processing to be conducted in the high-speed image forming system;

FIG. 11 shows a flowchart of a test copy processing in which two kinds of instruction information for shifting to a test copy mode are employed;

FIG. 12 shows a block diagram of a controlling configuration of a high-speed image forming system embodied in the present invention as the third embodiment;

FIG. 13 shows a flowchart of a confirmation copy output processing;

FIG. 14(a) shows an example of a confirmation output setting screen, while FIG. 14(b) shows an example of a confirmation copy output detail setting screen;

FIG. 15 shows a cross sectional configuration of an example of an image forming apparatus embodied in the present invention as the fourth embodiment;

FIG. 16 shows a block diagram of a first controlling mode of an image forming apparatus embodied in the present invention as the fourth embodiment;

FIG. 17 shows a flowchart (first page) of a controlling mode of an image forming apparatus embodied in the present invention as the fourth embodiment;

FIG. 18 shows an explanatory schematic diagram of an example of a confirmation-image outputting time selecting screen for selecting a time when outputting the confirmation image;

FIG. 19 shows an explanatory schematic diagram of an example of a confirmation-image selecting screen for selecting the confirmation image;

FIG. 20 shows an explanatory schematic diagram of an example of a job image designating screen for designating a specific job image to be employed as a confirmation image among various kinds of job images;

FIG. 21 shows an explanatory schematic diagram of an example of a selecting screen for selecting whether or not the job should be suspended at the time when outputting the confirmation image;

FIG. 22 shows a flowchart (second page) of a controlling mode of an image forming apparatus embodied in the present invention as the fourth embodiment;

FIG. 23 shows a flowchart (second page) of a controlling mode of an image forming apparatus embodied in the present invention as the fourth embodiment;

FIG. 24 shows a flowchart (third page) of a controlling mode of an image forming apparatus embodied in the present invention as the fourth embodiment;

FIG. 25 shows a flowchart (fourth page) of a controlling mode of an image forming apparatus embodied in the present invention as the fourth embodiment;

FIG. 26 shows an explanatory schematic diagram of a paper feeding apparatus;

FIG. 27 shows an explanatory block diagram of a post-processing apparatus; and

FIG. 28 shows an explanatory schematic diagram of an image forming system embodied in the present invention as the fourth embodiment.

### DETAILED DESCRIPTION OF THE PREFERRED EMBODIMENT

### First Embodiment

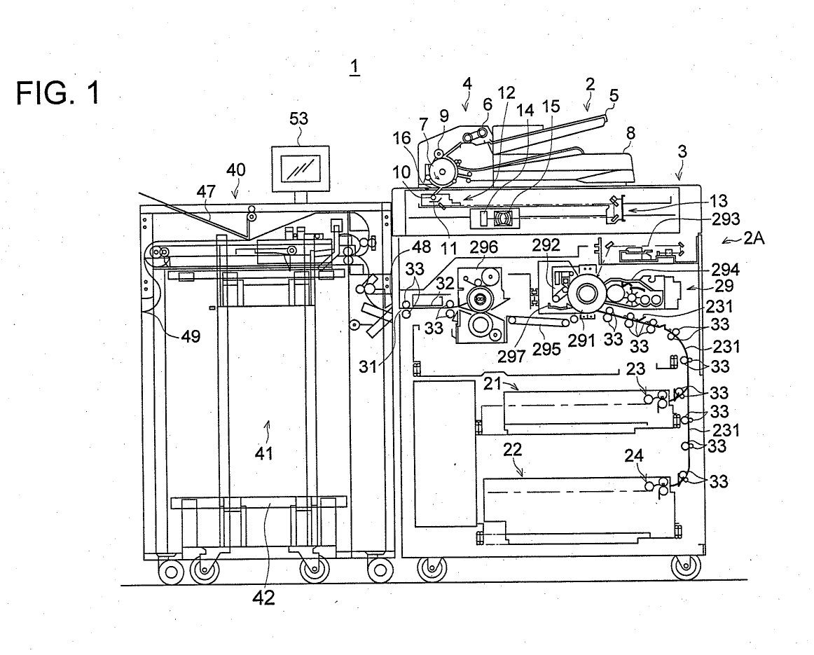

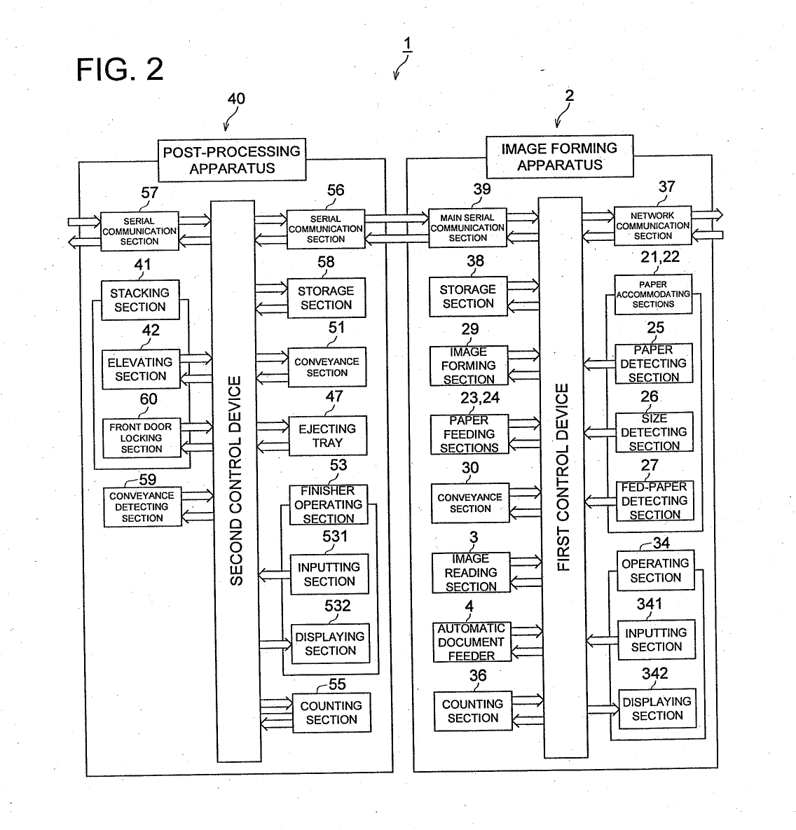

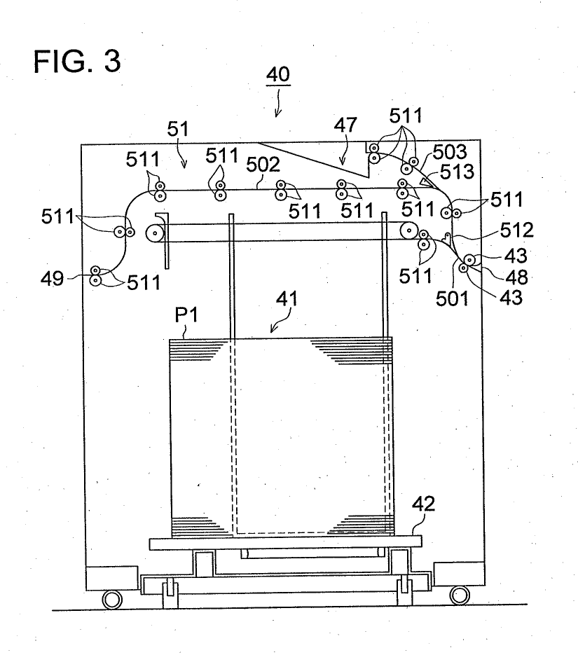

Referring to the drawings, an image forming system 1 embodied in the present invention will be detailed in the following as the first embodiment. However, the scope of the present invention is not limited to the examples shown in the following drawings. FIG. 1 shows a cross sectional view of the brief configuration of the image forming system 1, FIG. 2 shows a block diagram of the main controlling configuration of the image forming system 1 and FIG. 3 shows a schematic diagram of a configuration of the main part of a post-processing apparatus 40.

As shown in FIG. 1, the image forming system 1 is provided with an image forming apparatus 2 for forming and image on a paper P serving as a recording material, and a post-processing apparatus that is coupled to the image forming apparatus 2, and stacks the paper P (hereinafter, also referred to as a copy P1) on which the image is already formed and which is ejected from the image forming apparatus 2.

Initially, referring to FIG. 1 and FIG. 2, the image forming apparatus 2 will be detailed in the following.

As shown in FIG. 1, the image forming apparatus 2 is provided with an image forming apparatus proper 2A for forming an image onto the paper P. An image reading section 3 for reading an image to be formed on the paper P from a document is mounted at an upper side of the image forming apparatus proper 2A, and further, an automatic document feeder 4 for automatically feeding the document to the image reading section 3 is disposed at an upper region of the image reading section 3.

The automatic document feeder 4 has a document stacking tray 5 for stacking documents on it, at one end of which a document feeding roller 6 for feeding the document one by one is disposed. A document supporting roller 7 for supporting the document while rotating is disposed at a lower side of the document stacking tray 5, and further, a document ejecting tray 8 for ejecting the document, whose image is already read, is disposed at a lower region of the document stacking tray 5. Further, there is disposed inside the automatic document feeder 4, a document conveyance roller 9 for ejecting the document onto the document ejecting tray 8, after the document, sent from the document stacking tray 5, is conveyed to the upper region on the circumferential surface of the document supporting roller 7 and conveyed along the circumferential surface of the document supporting roller 7.

The image reading section 3 is provided with a first mirror unit 12 integrally constituted by a light source 10 for irradiating light onto the document and a mirror 11 for reflecting light coming from the document, and a second mirror unit 13 for further reflecting the light coming from the first mirror unit 12. The first mirror unit 12 and the second mirror unit 13 are equipped in such a manner that both can freely move in a horizontal direction (a right-left direction) shown in FIG. 1. Further, the image reading section 3 includes an image capturing element 14 for conducting photo-electronic converting actions, such as, for instance, a CCD (Charge Coupled Device), and a lens 15 disposed in front of the image capturing element 14 for focusing the light coming from the second mirror unit 13.

A slit 16 through which the light is irradiated onto the document conveyed along the document supporting roller 7 is disposed at the lower side of the document supporting roller 7. In the image reading section 3, the first mirror unit 12 is disposed under the slit 16 so as to read the image. Further, the automatic document feeder 4 is mounted on the image reading section 3 in such a manner that the automatic document feeder 4 can be freely opened and closed relative to the image reading section 3. A platen glass for putting the document on it covers the upper side of the image reading section 3, so that the image reading section 3 can also read the image of the document put on the platen glass by scanning the first mirror unit 12 and the second mirror unit 13.

Paper accommodating sections 21, 22 for accommodating a plurality of stacked papers PS are separately disposed at upper and lower positions over two stages. Each of paper feeding sections 23, 24 for feeding paper P, on which the image is to be recorded, one by one from each of the paper accommodating sections 21, 22 is disposed at an upper side of the one end of each of the paper accommodating sections 21, 22. Further, the paper accommodating sections 21, 22 are provided with a paper detecting section 25 for detecting presence or absence of the paper P, a size detecting section 26 for detecting the size of the paper P and a fed-paper detecting section 27 for detecting the paper P fed from the paper accommodating sections 21, 22 (indicated in FIG. 2).

The image forming section 29 is arranged in an upper space located above the paper accommodating sections 21, 22. The image forming section 29 is constituted by a photoreceptor drum 291, a charging section 292, an exposing section 293, a developing section 294, a transferring section 295, a fixing section 296 and a cleaning section 297.

The photoreceptor drum 291 is driven to rotate in a clockwise direction as shown in FIG. 1 by a photoreceptor drum driving mechanism (not shown in the drawings). The charging section 292 is disposed at an upper region near the circumferential surface of the photoreceptor drum 291, so that the charging section 292 generates the corona discharging action for uniformly charging the circumferential surface of the photoreceptor drum 291.

The exposing section 293, having an exposing light source, such as, for instance, a laser diode, is disposed at a position downstream from the charging section 292 in the rotating direction of the photoreceptor drum 291 and near the circumferential surface of the photoreceptor drum 291. Based on image signals, the exposing section 293 applies an image exposing operation onto the photoreceptor drum 291, so as to form an electrostatic latent image by attenuating or eliminating the electric charges residing on the circumferential surface of the photoreceptor drum 291.

The developing section 294 is disposed at a position downstream from the exposing section 293 in the rotating direction of the photoreceptor drum 291 and near the circumferential surface of the photoreceptor drum 291. The developing section 294 develops the electrostatic latent residing on the circumferential surface of the photoreceptor drum 291.

The transferring section 295 is disposed at a position downstream from the developing section 294 in the rotating direction of the photoreceptor drum 291 and near the circumferential surface of the photoreceptor drum 291. A conveyance path for conveying the paper P is formed between the transferring section 295 and the photoreceptor drum 291. The transferring section 295 generates the corona discharging action against the reverse surface of the paper P in a state that the paper P is pressed to the photoreceptor drum 291, so as to electrostatically transfer a toner image onto the paper P. In addition, the transferring section 295 also discharges the charged paper P, so as to separate the paper P from the photoreceptor drum 291.

The fixing section 296 is disposed at a position downstream from the conveyance path of the paper P of the transferring section 295. The fixing section 296 applies heat and pressure onto the paper P, so as to fix the toner image onto the paper P.

The cleaning section 297 is disposed at a position downstream from the transferring section 295 in the rotating direction of the photoreceptor drum 291 and near the circumferential surface of the photoreceptor drum 291. The cleaning section 297 press-contacts the circumferential surface of the photoreceptor drum 291, so as to clean and remove residual toner.

An ejecting outlet 31, for ejecting the paper P on which the image is already formed, namely, a copy P1, is disposed at a side section of the image forming apparatus 2.

The image forming apparatus 2 is provided with a feeding conveyance path 231 for conveying the paper P fed from the paper accommodating sections 21, 22 to the image forming section 29, a common conveyance path 32 for conveying the paper P, onto which the image forming section 29 already formed the image, to the ejecting outlet 31, and a conveyance section 30 for conveying the paper P residing in the feeding conveyance path 231 and the common conveyance path 32 by driving a plurality of rollers disposed at predetermined positions within the feeding conveyance path 231 and the common conveyance path 32.

Further, an operating section 34, including an inputting section 341 for operating the image forming apparatus 2 and a displaying section 342, is disposed at an upper section of the image forming apparatus 2. The displaying section 342 of the operating section 34, constituted by a LCD (Liquid Crystal Display), etc., displays various kinds of setting screens, a status of the image concerned, operating statuses of various kinds of functions on its screen. A touch panel, serving as the inputting section 341, is mounted on the screen of the LCD, so as to detect X-Y coordinate values of a power point pressed by a finger, a touch pen, etc., as voltage values, and then, to output the detected positional signals to a first control device 35 as operational signals. Further, the inputting section 341 is provided with various kinds of operational buttons for inputting various kinds of instructions, such as numerical buttons (not shown in the drawings), functional buttons for switching various kinds of settings and operation modes, a start buttons, etc.

For instance, since the displaying section 342 displays a setting screen for setting finish conditions, such as a number of output copies, a size of the finished paper, density of the image, a reduction rate, a color appearance (in the case of the color image forming apparatus), etc., it is possible to input setting information, such as a number of output copies, the finish conditions, etc., from the setting screen, serving as the inputting section 341.

Further, the image forming apparatus 2 is provided with the first control device 35 including a CPU (Central Processing Unit), etc., for controlling the various sections. As shown in FIG. 2, the first control device 35 is coupled to the image reading section 3, the automatic document feeder 4, the paper feeding sections 23, 24, the image forming section 29, the inputting section 341, the displaying section 342, the conveyance section 30, the paper detecting section 25, the size detecting section 26, the fed-paper detecting section 27, a counting section 36 for counting a number of papers on which images are to be formed, a network communication section 37 coupled to various kinds of communication lines, a storage section 38 for storing various kinds of controlling programs and various kinds of data in it, and a main serial communication section 39 to be coupled to the post-processing apparatus 40. Further, other than the above, the first control device 35 is also coupled to various kinds of driving sections, etc. provided in the image forming apparatus 2. Accordingly, the first control device 35 controls the various kinds of devices, based on the controlling programs and the various kinds of data stored in the storage section 38.

Still further, at the time of commencing an image forming job, the first control device 35 detects a number of sheets per one set (copy), based on a number of pages represented by the inputted image data, and then, outputs job information, including a number of copies to be outputted and the number of sheets per one copy, to a second control device 54 of the post-processing apparatus 40 through the main serial communication section 39. Hereinafter, the term of “job” (an image forming job) is defined as consecutive actions in respect to an image forming operation, such as a printing operation, etc. For instance, when copying a plurality of document sheets, the consecutive actions, in respect to the copying operation for the plurality of document sheets, is regarded as one job, while, when copying a plurality of copies, the consecutive actions, in respect to the copying operation for the plurality of copies, is regarded as one job. The consecutive actions mentioned in the above include the stacking actions performed in the post-processing apparatus 40. Incidentally, plural sheets of copy P1 in a range of 4000-5000 sheets can be stacked in the post-processing apparatus 40. The image forming job to be performed in the image forming system 1 is to continuously perform image forming operations for the plural sheets and to stack them one by one into the post-processing apparatus 40.

Incidentally, although the image forming apparatus employing the electro-photographic method is exemplified as the image forming apparatus 2 embodied in the present invention, any kind of image forming apparatus is applicable for the present invention. Other than the above-cited image forming apparatus, an image forming apparatuses, which employs a thermal printing method, an ink-jet printing method, etc., can be cited as another applicable image forming apparatus. Further, a printer, a copier, a facsimile, a compound apparatus of them, etc. could be also cited as the image forming apparatus 2.

Next, referring to FIG. 2 and FIG. 3, the post-processing apparatus 40 will be detailed in the following.

As shown in FIG. 3, a stacking section 41, for stacking the copy P1 on which the image is formed one by one on it, is disposed inside the post-processing apparatus 40. The stacking section 41 is provided with an elevating section 42, being movable in the vertical direction. When none of copy P1 are stacked on the stacking section 41, the elevating section 42 is positioned at the upper-most position, and then, according as plural sheets of the copy P1 are stacked, the elevating section 42 gradually descends downwards, and, when the stacked sheets of the copy P1 are removed from the stacking section 41, the elevating section 42 elevates again to the upper-most position.

An ejecting tray 47 is disposed at the upper side of the post-processing apparatus 40 in such a manner that the copy P1 is stacked outside the apparatus so that the operator can easily take out the copy P1. Further, an inlet opening 48, which is connected to the ejecting outlet 31 of the image forming apparatus 2 and from which the copy P1 is conveyed into the post-processing apparatus 40, is equipped at a side section of the post-processing apparatus 40, while a conveyance opening 49 from which the copy P1 is conveyed out, is equipped at another side section of the post-processing apparatus 40. A conveyance detecting section 59, for detecting the copy P1 currently conveyed, is disposed near the inlet opening 48. Further, the post-processing apparatus 40 is provided with a stacking path 501 for conveying the copy P1 from the inlet opening 48 to the stacking section 41, an ejecting path 502 branching out the stacking path 501 for conveying the copy P1 to the conveyance opening 49 and a sub-conveyance path 503 branching out the ejecting path 502 for conveying the copy P1 to the ejecting tray 47. Still further, a first switching section 513, for switching the conveyance destination to either the conveyance opening 49 or the ejecting tray 47, is disposed at a branching point of the sub-conveyance path 503.

Still further, a second switching section 512, for switching the conveyance path to either the stacking path 501 or the ejecting path 502, is disposed at a branching point at which the ejecting path 502 branches out the stacking path 501. Still further, a plurality of pairs of rollers 511 are disposed in the stacking path 501, the ejecting path 502 and sub-conveyance path 503, so that rotating actions of the pairs of rollers 511 allow the copy P1 to be conveyed through the stacking path 501, the ejecting path 502 and sub-conveyance path 503. The plurality of pairs of rollers 511, the second switching section 512 and the first switching section 513 constitute a conveyance section 51.

Still further, a finisher operating section 53, including a inputting section 531 and a displaying section 532, is disposed at an upper side of the post-processing apparatus 40. The displaying section 532 of the finisher operating section 53 is constituted by the LCD, etc., so as to display various kinds of operational buttons, various kinds of setting screens, an image status, operating statuses of various kinds of functions, etc. A touch panel, serving as the inputting section 531, is mounted on the screen of the LCD, so as to detect X-Y coordinate values of a power point pressed by a finger, a touch pen, etc., as voltage values, and then, to output the detected positional signals to the second control device 54 as operational signals. The finisher operating section 53 displays, for instance, a finished-quality confirmation instruction button, serving as an instruction inputting section for inputting instruction information with respect to a confirmation output for confirming the finished status of the image (detailed later). When detecting the push-down operation of the finished-quality confirmation instruction button, the finisher operating section 53 outputs the instruction information for instructing the implementation of the confirmation output to the second control device 54. Further, the inputting section 531 is also provided with various kinds of other operational buttons, such as numerical buttons (not shown in the drawings), etc.

Further, the post-processing apparatus 40 is provided with the second control device 54 including a CPU (Central Processing Unit), etc., for controlling the various sections. As shown in FIG. 2, the second control device 54 is electrically coupled to the conveyance section 51, the ejecting tray 47, the inputting section 531, the displaying section 532, the elevating section 42, a counting section 55 for counting a number of sheets of the copy P1 conveyed from the image forming apparatus 2, a serial communication section 57 to be coupled to a next post-processing apparatus when serially coupling a plurality of post-processing apparatuses, a storage section 58 for storing various kinds of controlling programs and various kinds of data in it, and a front door locking section 60 for locking or releasing a locking mechanism equipped at a paper taking outlet of the stacking section 41.

Further, other than the abovementioned section, the second control device 54 is also coupled to various kinds of driving sections, etc. provided in the post-processing apparatus 40. Accordingly, the second control device 54 controls the various kinds of devices, according to the controlling actions of the first control device 35 of the image forming apparatus 2 and the controlling programs stored in the storage section 58.

Incidentally, a plurality of post-processing apparatuses, each of which serves as the post-processing apparatus 40, can be cascaded in a serial coupling mode. When coupling two post-processing apparatuses 40, the conveyance opening 49 of the first post-processing apparatus 40-1, which is coupled to the image forming apparatus 2, is connected to the inlet opening 48 of the second post-processing apparatus 40-2 to be coupled to the first post-processing apparatus 40-1. According to this connection, the ejecting path 502 of the first post-processing apparatus 40-1 is jointed to the stacking path 501 of the second post-processing apparatus 40-2. Accordingly, the copy P1, to be stacked on the stacking section 41 of the second post-processing apparatus 40-2, is conveyed to the destination by passing through the ejecting path 502 of the first post-processing apparatus 40-1 and the ejecting path 502 of the second post-processing apparatus 40-2.

When coupling the third post-processing apparatus 40-3, the inlet opening 48 and a serial communication section 56 of the third post-processing apparatus 40-3 are respectively coupled to the conveyance opening 49 and the serial communication section 57 of the second post-processing apparatus 40-2. In the same manner as the above, a plurality of post-processing apparatuses, each of which serves as the post-processing apparatus 40, can be cascaded in the serial coupling mode.

Next, operations of the image forming system 1 embodied in the present invention will be detailed in the following.

When a document is put on the document stacking tray 5, and setting items, such as a number of copies, etc., are inputted from the operating section 34, and an image forming instruction (such as, a copy start, etc.) is inputted, the first control device 35 conducts consecutive operations including the steps of: transmitting a commencing instruction of the image forming job to the second control device 54 of the post-processing apparatus 40 through the main serial communication section 39; conveying a document sheet one by one from the document, stacked on the document stacking tray 5, to the image reading section 3; reading the images of the document by means of the image reading section 3 to acquire image data of the document; detecting a number of sheets per one copy from the page number of the image data; and outputting the job information including a inputted number of sheets to be outputted and the detected number of sheets per one copy to the second control device 54 of the post-processing apparatus 40 through the main serial communication section 39.

Further, the first control device 35 selects any one of the paper accommodating sections 21, 22 for which the detecting result of the paper detecting section 25 indicates “presence”, and then, controls corresponding one of the paper feeding sections 23, 24 and the conveyance section 30, so as to convey the paper P to the image forming section 29.

When the paper P is conveyed to the image forming section 29, the first control device 35 controls the image forming section 29 to conduct consecutive operations including the steps of: uniformly charging the circumferential surface of the photoreceptor drum 291 by activating the charging section 292; exposing modulated light onto the circumferential surface of the photoreceptor drum 291 based on the image data read by the image reading section 3 in order to form an electrostatic latent image on it by controlling the exposing section 293; and developing the electrostatic latent image with toner by activating the developing section 294 so as to form a toner image.

When the toner image passes above the conveyance path, and the paper P is conveyed below the photoreceptor drum 291, the first control device 35 conveys the paper P, and controls the transferring section 295 so as to transfer the toner image onto the paper P, and then, controls the fixing section 296 so as to fix the toner image onto the paper P. Then, the first control device 35 controls the conveyance section 30 so as to eject the copy P1, on which the toner image is already formed, from the ejecting outlet 31 after the copy P1 passes through the common conveyance path 32. After that, the cleaning section 297 cleans the residual toner remained on the circumferential surface of the photoreceptor drum 291 to prepare for the next image forming operation.

When the copy P1 arrives at the ejecting outlet 31 after passing through the common conveyance path 32, and enters into the post-processing apparatus 40 from the inlet opening 48, and then, the conveyance detecting section 59, disposed near the inlet opening 48, detects the copy P1 coming into the post-processing apparatus 40, the second control device 54 controls the counting section 55 to increase the count value by “1”, and conveys the copy P1 to either the stacking section 41 or the ejecting tray 47, corresponding to the job information and the counted value of the counting section 55.

Incidentally, in the post-processing apparatus 40, the copy P1 is conveyed to the stacking section 41 and stacked one by one on it. Accordingly, during the stacking operation, the front door is shut and locked by the front door locking section 60 in order to protect the stacking section 41 from mechanical hazards. Therefore, during the stacking operation of the copy P1, it is impossible for the operator to pick up one of copies from the stacking section 41 in order to confirm its finished status.

To overcome the abovementioned problem, in the embodiment of the present invention, the second control device 54 controls the finisher operating section 53 to display the finished-quality confirmation instruction button, which is pushed down by the operator in order to input instruction information indicating an instruction for implementing the confirmation output for confirming the finished status of the image formed on the copy P1, on the displaying section 532. When the operator pushes down the finished-quality confirmation instruction button through the inputting section 531, the second control device 54 controls the conveyance section 51 so as to eject the copy P1 in a unit of one copy onto the ejecting tray 47 so that the operator can easily pick up the copy P1. Accordingly, it becomes possible for the operator to confirm the finished status of the image formed on the copy P1 at any time during the execution of the image forming job as required.

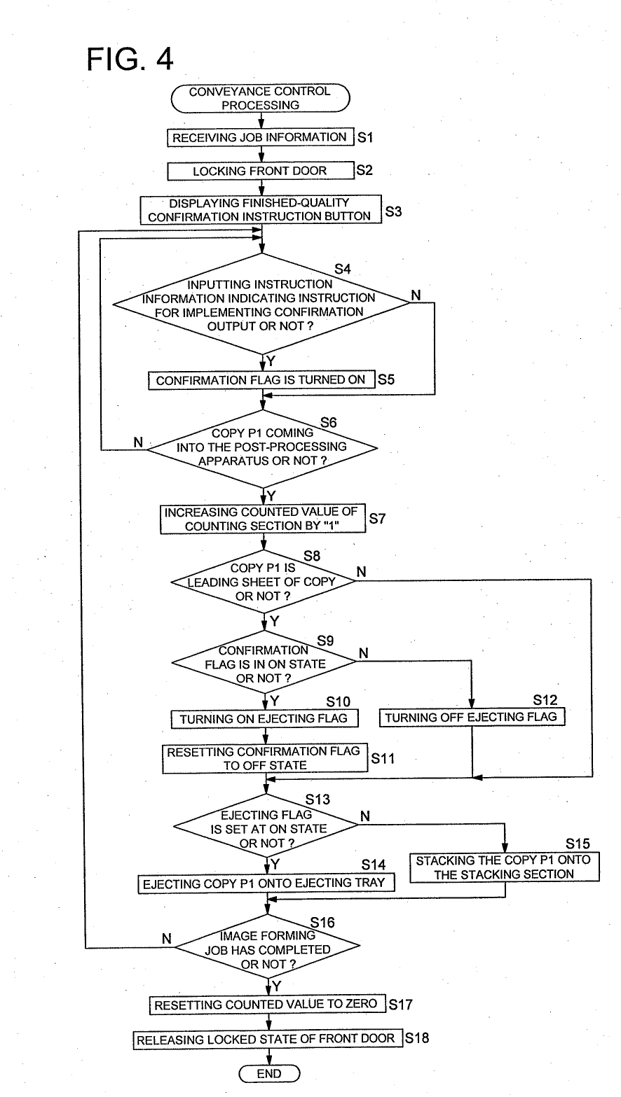

FIG. 4 shows a flowchart of the conveyance control processing to be implemented in the second control device 54, when receiving an instruction for commencing the image forming job from the image forming apparatus 2 through the serial communication section 56. The conveyance control processing is implemented as software processing executed by the combined operations of the second control device 54 and the conveyance control program stored in the storage section 58.

Initially, the second control device 54 receives the job information, including a number of output copies and a number of sheets per one copy, from the first control device 35 of the image forming apparatus 2 through the serial communication section 56 (Step S1). Further, the second control device 54 controls the front door locking section 60 so as to lock the front door (Step S2), and controls the finisher operating section 53 so as to display the finished-quality confirmation instruction button, serving as an instruction inputting section, on the displaying section 532 (Step S3).

Successively, the second control device 54 determines whether or not the finished-quality confirmation instruction button is pushed down through the inputting section 531. When the finished-quality confirmation instruction button is pushed down in order to input the instruction information indicating the instruction for implementing the confirmation output (Step S4, Yes), the confirmation flag is turned ON (Step S5), and then, the processing enters into Step S6. When the finished-quality confirmation instruction button is not pushed down (Step S4, No), the processing directly enters into Step S6.

In Step S6, when the conveyance detecting section 59 detects the copy P1 coming into the post-processing apparatus 40 (Step S6, Yes), the second control device 54 controls the counting section 55 so as to increase the counted value by “1” (Step S7), and then, determines whether or not the copy P1 is a leading sheet of the (a unit) copy, based on the job information and the counted value of the counting section 55 (Step S8). When determining that the copy P1 is not a leading sheet of the (a unit) copy (Step S8, No), the second control device 54 enters into the processing of Step S13.

When determining that the copy P1 is a leading sheet of the (a unit) copy (Step S8, No), the second control device 54 refers to the confirmation flag (Step S9). When the confirmation flag is in ON state (Step S9, Yes), the second control device 54 turns ON the ejecting flag (Step S10), and resets the confirmation flag to OFF state (Step S11). When the confirmation flag is in OFF state (Step S9, No), the second control device 54 turns OFF the ejecting flag (Step S12), and enters into the processing of Step S13.

In Step S13, the second control device 54 refers to the ejecting flag. When the ejecting flag is set at ON state (Step S13, Yes), the second control device 54 controls the conveyance section 51 so as to convey the copy P1, coming from the inlet opening 48, to the ejecting tray 47 through the sub-conveyance path 503 in order to eject the copy P1 onto the ejecting tray 47 (Step S14). While, when the ejecting flag is set at OFF state (Step S13, No), the second control device 54 controls the conveyance section 51 so as to convey the copy P1, coming from the inlet opening 48, to the stacking section 41 through the stacking path 501 in order to stack the copy P1 onto the stacking section 41 (Step S15).

Incidentally, in the case that a plurality of post-processing apparatuses, each of which serves as the post-processing apparatus 40, are cascaded in serial, when an amount of sheets of the copy P1 stacked in the stacking section 41 reaches to a predetermined amount (for instance, predetermined number of sheets), the second control device 54 controls the conveyance section 51 so as to change the conveyance destination of the copy P1, to be conveyed to the stacking section 41, to the conveyance opening 49, and so as to output the conveyance instruction, for conveying the paper P to a next stacking section 41′, to a next second control device 54′, and further, so as to convey the copy P1, coming from the inlet opening 48, into the next post-processing apparatus 40′ from a next inlet opening 48′ through the ejecting path 502.

After conveying the copy P1 carried in, based on the instruction sent from the first control device 35, the second control device 54 determines whether or not the image forming job has completed (Step S16). When determining that the image forming job has not completed (Step S16, No), the second control device 54 returns to the processing of Step S4, in order to repeat the processing operations from Step S4 to Step S15. When determining that the image forming job has completed (Step S16, Yes), the second control device 54 controls the counting section 55 so as to reset the counted value to zero (Step S17), and controls the front door locking section 60 so as to release the locked state of the front door (Step S18). Then, the conveyance control processing is finalized.

As described in the foregoing, according to the image forming system 1, when the instruction information indicating the instruction for implementing the confirmation output is inputted during the execution of the image forming job, the post-processing apparatus 40 successively ejects the copy P1, on which the toner image is already formed, on by one onto the ejecting tray 47 from the leading paper to the final paper included one copy of the document.

Accordingly, it becomes possible for the operator to confirm the finished status of the reproduced image at any time during the execution of the image forming job as required, without halting the operations. Further, since the sheets of copy P1 are ejected onto the ejecting tray 47 in a unit of one copy of the document, it becomes possible to ejects the proofing sheets for confirming the finished status without occurring such a deficiency that one copy set is not arranged on the stacking section 41 since some pages, which are included in one copy, are ejected from the ejecting section, or a copy, having a lack of page, is mingled.

Incidentally, the image forming system 1 described in the foregoing is merely a preferable one of the image forming systems embodied in the present invention. The scope of the present invention is not limited to the image forming system 1 described in the foregoing.

For instance, although, in the aforementioned embodiment, the image forming job is exemplified as such a job for reading the image of the document to output the paper on which the image is formed, the present invention can be also applied to such a job for conducting a printout operation based on the image data sent from an external host apparatus, if the external host apparatus is coupled to the image forming apparatus 2 through the network communication section 37.

Further, although the finisher operating section 53 of the post-processing apparatus 40 is provided with the instruction inputting section for inputting the instruction information indicating the instruction for implementing the confirmation output to confirm the finished status of the copy P1 in the abovementioned embodiment, it is also applicable that the operating section 34 of the image forming apparatus 2 is provided with the instruction inputting section, so as to transmit the instruction information indicating the instruction for implementing the confirmation output to the second control device 54 from the first control device 35 at the time when the instruction information indicating the instruction for implementing the confirmation output is inputted from the operating section 34. Still further, it is also applicable that the external host apparatus is provided with the instruction inputting section, so as to transmit the instruction information indicating the instruction for implementing the confirmation output to the second control device 54 from the first control device 35 at the time when the external host apparatus transmits the instruction information indicating the instruction for implementing the confirmation output to the first control device 35 through the network communication section 37.

Still further, it is also applicable that, when inputting the instruction information indicating the instruction for implementing the confirmation output from the instruction inputting section, the operator can input the selection of whether or not the copy P1 ejected from the ejecting tray 47 should be included into the total number of sheets of the image forming job concerned, while the second control device 54 outputs instruction information for implementing image forming operations a number of times corresponding to the inputted contents. According to the above, it becomes possible for the operator to determine whether or not the paper sheets on which the images are already formed and which is ejected from the ejecting tray 47 should be included in the total number of sheets to be outputted, resulting in an improvement of the maneuverability of the system.

Still further, although the ejecting operation (namely, the confirmation outputting operation) of the paper sheets for confirming the finished status is conducted in response to the operator's instruction inputted at any time during the execution of the image forming job in the aforementioned embodiment, it is also applicable that the system is so constituted that instruction information, for determining in advance a copy number of paper sheets to be outputted as the paper sheets for confirming the finished status, can be established in the instruction inputting section, and the second control device 54 controls the post-processing apparatus 40 so as to eject the paper sheets, on which the images are already formed, onto the ejecting tray 47 at the time of copying the established copy number. Still further, it is also applicable that the system is so constituted that instruction information, for instructing that the confirmation outputting operation should be conducted for every predetermined number of copies (N copies (N is a positive integer)), can be established in the instruction inputting section, and the second control device 54 controls the post-processing apparatus 40 so as to eject the paper sheets, on which the images are already formed, onto the ejecting tray 47 for every predetermined number of copies. According to the above, it becomes possible for the operator to easily confirm the finished status of the images at intervals of the predetermined number of copies.

Other than the above, with respect to the detailed configurations and the detailed operations of the image forming system 1 and each of the sections for the same, the disclosed embodiments can be varied by a skilled person without departing from the spirit and scope of the invention.

### Second Embodiment

Referring to the drawings, the second embodiment of the present invention will be detailed in the following. However, the scope of the present invention is not limited to the examples shown in the drawings.

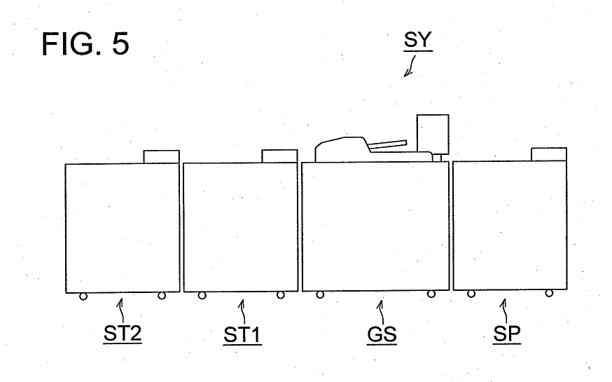

FIG. 5 shows an exemplified configuration of a high-speed image forming system SY embodied in the present invention as the second embodiment.

As shown in FIG. 5, the high-speed image forming system SY is constituted by a high-speed image forming apparatus GS, a paper feeding apparatus Specifically and copy stackers ST1, ST2.

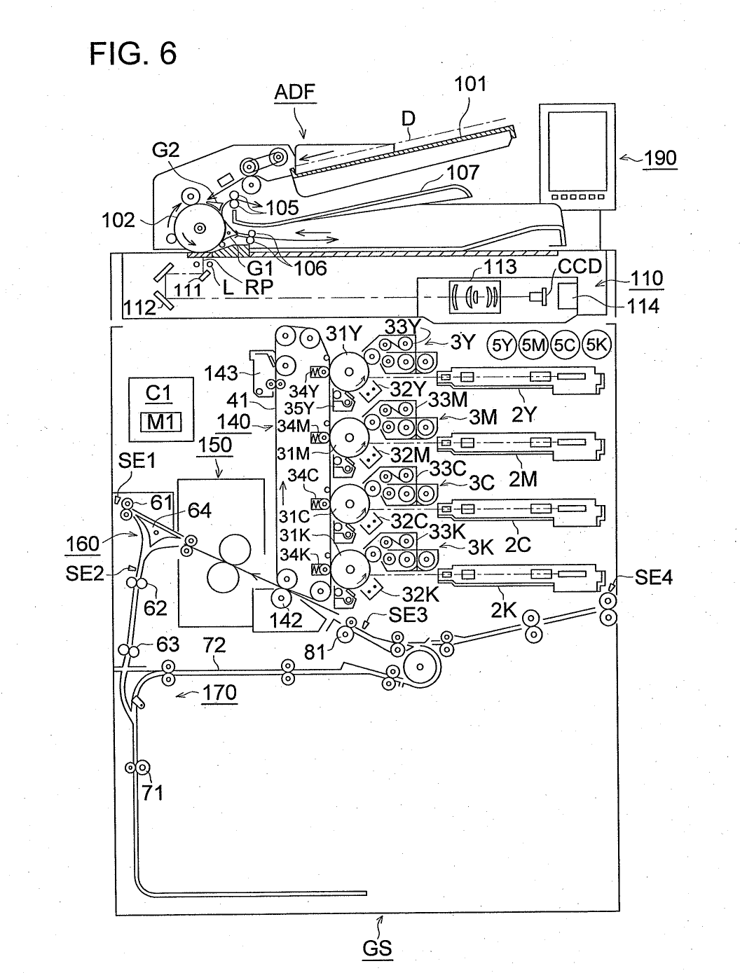

FIG. 6 shows a conceptual schematic diagram of the high-speed image forming apparatus GS.

The high-speed image forming apparatus GS is a color image forming apparatus, which is provided with an automatic document feeder ADF disposed at the upper side of the apparatus, as shown in FIG. 6.

The paper sheets of a document D stacked on a document stacking tray 101 are separately fed one by one to a document conveying path, and conveyed by a conveying drum 102. A document reading section 110 reads an original image, residing on the document D currently conveyed, at a document-image reading position RP. After the reading operation is completed, the document D is ejected onto a document ejecting tray 107 by means of a first conveyance guide G1 and document ejecting rollers 105.

When reading an original image residing on the reverse side of the document D in addition to that on the obverse side, the document D for which the reading operation of the obverse side (first side) is completed, is guided to a document reversing rollers 106 along a first conveyance guide G1, and then, the document reversing rollers 106 reverses its rotating direction at the time when clipping the trailing edge portion of the document D, so as to feed the document D back to the document conveying path through the first conveyance guide G1 and a second conveyance guide G2. The document reading section 110 reads the original image residing on the reverse side (second side) of the document D fed in a reversed state, as well as that on the obverse side (first side). Then, the document D is ejected onto the document ejecting tray 107.

The high-speed image forming apparatus GS is constituted by the document reading section 110, image writing sections 2Y, 2M, 2C, 2K, image forming sections 3Y, 3M, 3C, 3K, an image transferring section 140, a fixing section 150, a reverse ejecting section 160, a paper feeding back section 170, an operation displaying section 190, a controlling section C1, etc.

A lamp L irradiates light onto the document image at the document-image reading position RP. A first mirror unit 111, a second mirror unit 112 and a lens 113 guide the light reflected from the document image, so that the reflected light is projected onto a photo-receiving surface of a CCD serving as a image capturing element. Image signals generated by the photo-electronic converting actions performed in the CCD are further converted to digital image data by applying analogue-to-digital conversion processing performed in an image reading control section 114. In the image reading control section 114, the shading correction processing, the compression processing, etc. are further applied to the digital image data so as to generate document image data, which are stored in storage M1 of the controlling section C1.

A predetermined image processing, determined by the designation of the user or the conditions established in advance, is further applied to the document image data stored in the storage M1 so as to generate output image data.

Based on the output image data, latent images are formed on photoreceptor drums 31Y, 31M, 31C, 31K, by scanning laser beams emitted from the image writing sections 2Y, 2M, 2C, 2K, each of which includes a laser light source, a polygon mirror and a plurality of lenses, onto circumferential surfaces of the photoreceptor drums 31Y, 31M, 31C, 31K, serving as constituents of the image forming sections 3Y, 3M, 3C, 3K.

A charging section 32Y, a developing section 33Y, a first transferring roller 34Y and a cleaning section 35Y are disposed around the peripheral region of the photoreceptor drum 31Y, as well as each of the photoreceptor drums 31M, 31C, 31K. These configurations are well known as the conventional technology employed for the color image forming apparatus of the electro-photographic method.

Each of the latent images formed on the photoreceptor drums 31Y, 31M, 31C, 31K are developed by the corresponding one of developing sections 33Y, 31M, 31C, 31K so as to form a unicolor toner image on each of photoreceptor drums. Then, each of unicolor toner images is sequentially transferred onto a predetermined area on an intermediate transfer belt 141 by the corresponding one of first transferring rollers 34Y, 34M, 34C, 34K of the image transferring section 140.

The color toner image transferred onto the intermediate transfer belt 141 of the image transferring section 140 is further transferred onto a paper P, serving as a recording material, fed from the paper feeding apparatus SP while adjusting the paper feed timing by a paper feeding rollers 81, by means of a second transferring roller 14Z

After the operation for transferring the color toner image onto the paper P is completed, the surface of the intermediate transfer belt 141 is cleaned by the cleaning section 143 in order to prepare for the next image transferring operation.

On the other hand, the paper P bearing the color toner image is conveyed into the fixing section 150 so as to fix the color toner image onto the paper P by applying heat and pressure by clipping the paper P between a pressing roller and a heating roller, which are opposed to each other.

After the fixing operation in the fixing section 150 is completed, the paper P is conveyed to the copy stacker ST1 by ejecting rollers 61.

When ejecting the paper P in a reversed state between obverse and reverse sides, a switching guide 64 changes the conveyance direction of the paper P so as to guide it to reversing rollers 62, 63. Successively, after the reversing rollers 62 clips the trailing edge portion of the paper P, the rotating direction of the reversing rollers 62 is reversed so as to convey the paper P to the copy stacker ST1 by guiding the paper P towards the ejecting rollers 61 by means of the switching guide 64.

Incidentally, when forming an image onto the reverse side of the paper P, the paper P on obverse side of which the color toner image is already fixed, is conveyed to the paper feeding back section 170 located below the switching guide 64, and, after the reversing rollers 62 clips the trailing edge portion of the paper P, the surface of the paper P is reversed by feeding it back to a paper feedback path 72 so as to conduct the image forming operation for the reverse side of the paper P.

The operation displaying section 190 is equipped at an upper section of the high-speed image forming apparatus GS, and provided with a touch panel and a plurality of switches arranged at a lower section of the touch panel. This kind of the operation displaying section is widely and generally well known as a device for displaying images and for inputting various kinds of information. For instance, the operation displaying section 190 has functions of an instruction inputting section for inputting instruction information with respect to a confirmation output (proofing output) for confirming the finished status of the image during the execution of the image forming job, a setting section for setting or changing the image forming job including the image finishing conditions, and a resumption instructing section for inputting instruction information for resuming the image forming job suspended due to the operation shift to the proofing copy mode.

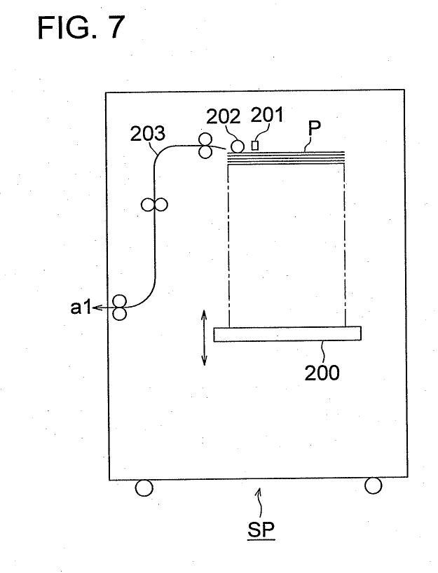

FIG. 7 shows a conceptual configuration of the paper feeding apparatus SP.

The paper feeding apparatus SP is a high-volume paper feeding apparatus configured on the basis of the generally well-known technologies.

Several thousands of papers can be stacked on a paper tray 200. The upper most surface of the paper P stacked is always positioned at a predetermined height by controlling the elevating or descending action of the paper tray 200, based on a signal detected by an upper surface detecting sensor 201. A paper feeding roller 202 sequentially feeds the paper P positioned at the upper most surface one by one to a conveyance path 203. Then, the paper P is conveyed toward the high-speed image forming apparatus GS located in a direction al.

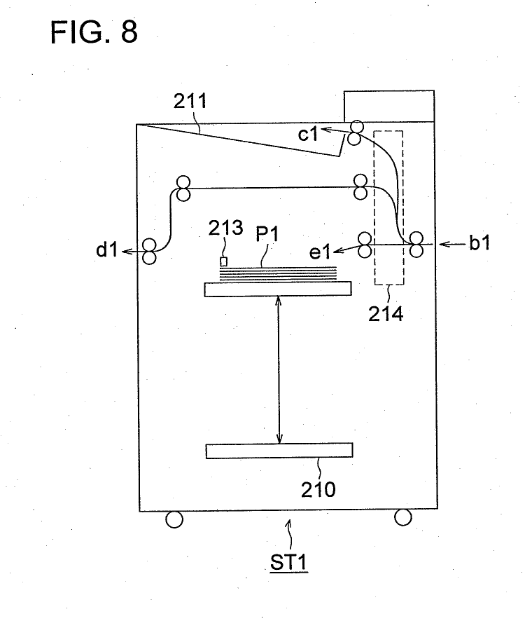

FIG. 8 shows a conceptual configuration of the copy stackers ST1, ST2. Incidentally, since the copy stackers ST1, ST2 have configurations being same as each other and can be coupled to each other over a plurality of them, only the copy stacker ST1 will be detailed in the following as a representative of them.

The copy stacker ST1 is a high-volume paper stacking apparatus configured on the basis of the generally well-known technologies. The copy stacker ST1 sequentially stacks the paper P (hereinafter, referred to as a copy P1) conveyed from a direction b1, and for this purpose, is provided with a first ejecting tray 210 for stacking a large amount of sheets of the copy P1 and a second ejecting tray 211 disposed at the upper side of the copy stacker ST1 for stacking a small amount of sheets of the copy P1.

The copy P1 conveyed from the direction b1 is further conveyed into one of the conveyance paths indicated by arrow c1, arrow d1 and arrow e1, respectively, which is switched by a conveyance path switching section 214 constituted by a plurality of movable guide and rollers (not shown in the drawings).

The copy P1 conveyed into the conveyance path of the direction c1 is ejected onto the second ejecting tray 211 serving as an ejecting section, so as to sequentially stack it one by one. Since the second ejecting tray 211, serving as a low-volume paper stacking apparatus, is disposed at the upper surface of the copy stacker ST1, it becomes possible for the operator to manually pick up the copy P1 by hand. Further, when the copy P1 is ejected on the second ejecting tray 211 in a face-up stacking mode, the operator can easily confirm its image quality.

The copy P1 conveyed into the conveyance path of the direction d1 is further conveyed into the copy stacker ST2.

The copy P1 conveyed into the conveyance path of the direction e1 is ejected onto the first ejecting tray 210, so as to sequentially stack it one by one. The first ejecting tray 210 is a high-volume paper stacking tray having a capability of stacking several thousands of papers. Incidentally, the copy stackers ST1, ST2 are so constituted that the copy P1 stacked on the first ejecting tray 210 is shielded from the external section during the operation for stacking it onto the first ejecting tray 210.

The height of the uppermost surface of the copy P1 is maintained at substantially a constant level by controlling the elevating or descending action of the first ejecting tray 210, based on the information detected by an upper surface detecting sensor 213.

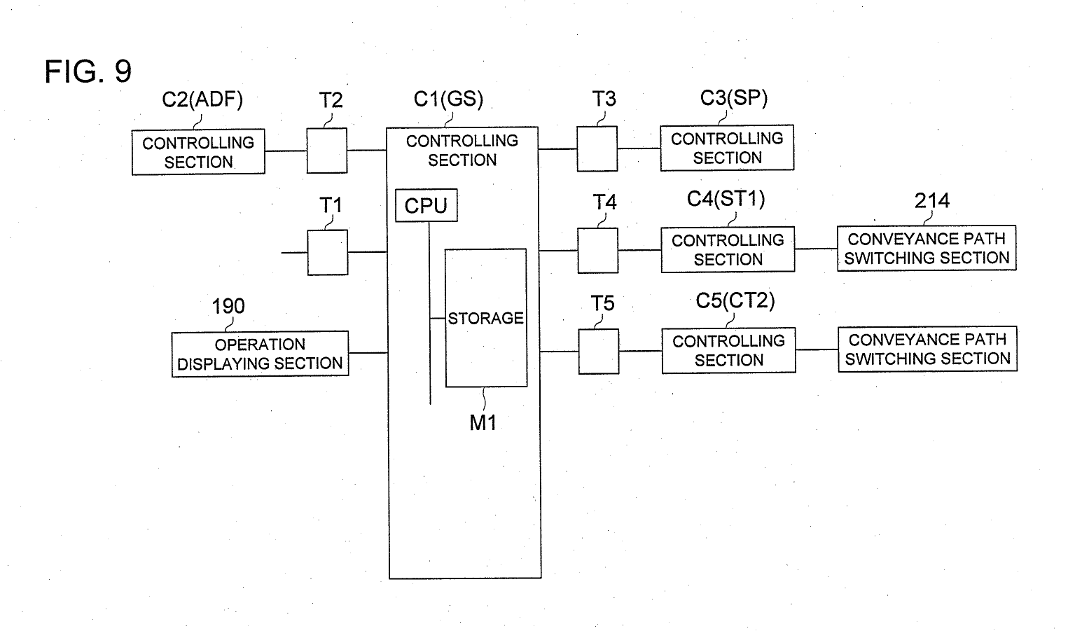

FIG. 9 shows a block diagram of a controlling configuration of the high-speed image forming system SY.

The controlling section C1 located in the high-speed image forming apparatus GS is configured as a computer system including a CPU, the storage M1, an I/O port, a communication interface and circuits for controlling driving operations of various sections. In addition, each of a controlling section C2 equipped in the automatic document feeder ADF, a controlling section C3 equipped in the paper feeding apparatus SP and controlling sections C4, C5 equipped in the copy stackers ST1, ST2 is also configured as a computer system of the same type, though the scale of each of them is relatively small.

The controlling section C1 conducts various controlling operations by executing the predetermined programs stored in the storage Ml. The controlling section C1 is coupled to the controlling sections C2, C3, C4, C5 through serial communication sections T2, T3, T4, T5. Further, the high-speed image forming apparatus GS can be coupled to another image forming apparatus or another image processing apparatus. In such the case, the controlling section C1 exchanges information with the other image forming apparatus or the other image processing apparatus through a communication section T1.

Incidentally, functional blocks, which are not directly related to the present invention, are omitted in FIG. 9. Further, for instance, sensors SE1, SE2, SE3, SE4, shown in FIG. 6 (not shown in FIG. 9) are coupled to the controlling section C1, so that the controlling section C1 controls a number of sheets, a number of copies, a number of pages, etc. in regard to the image forming job, based on the information detected by the sensors SE1, SE2, SE3, SE4.

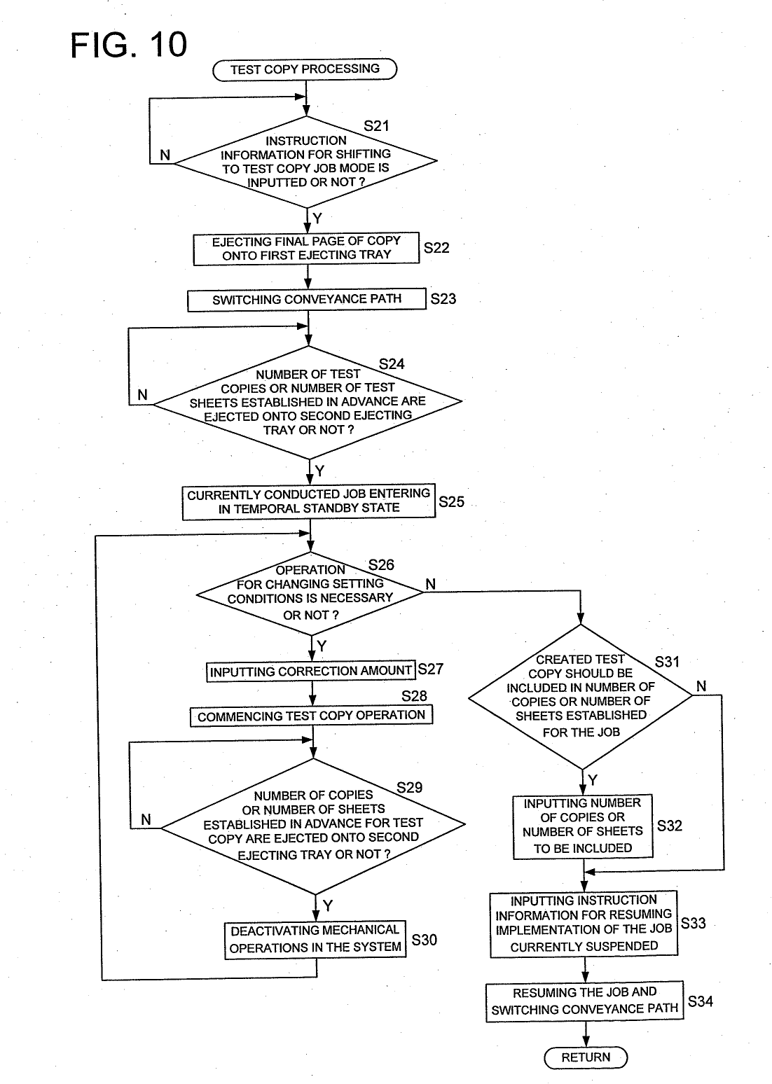

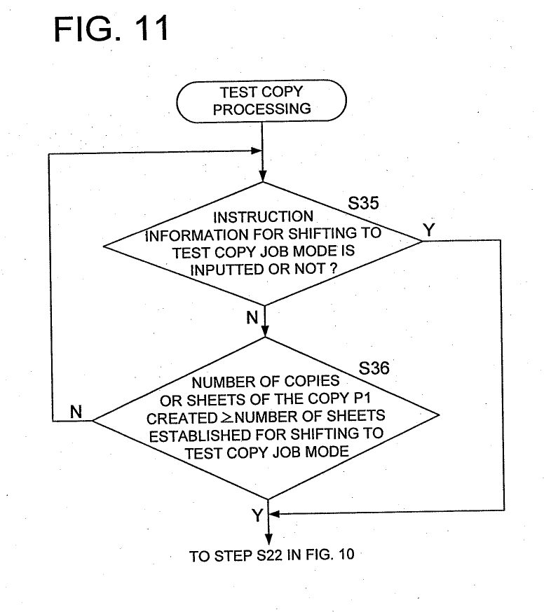

FIG. 10 shows a flowchart of a test copy processing to be conducted in the high-speed image forming system SY.

The high-speed image forming system SY is provided with a normal copy job mode in which copies are produced according to the conditions established for the job concerned, and a test copy job mode in which, preceding to the implementation of the job in the normal copy job mode or after suspending the job in a mid-course of the implementation of the job in the normal copy job mode, correcting conditions for correcting the finishing conditions established in the normal copy job mode are inputted so as to create a test copy under the corrected conditions. The job implemented in the normal copy job mode of the high-speed image forming system SY is to continuously conduct the copy operations for a plurality of sheets, and sequentially stack the sheets of the copy P1 one by one onto the first ejecting tray 210.

At a time when the creation of the copy P1 is currently conducted in the normal copy job mode, if the instruction information for shifting to the test copy job mode is inputted from the operation displaying section 190 (Step S21: Yes), the controlling section C1 of the high-speed image forming apparatus GS sends the mode change instruction to the controlling section C4 of the copy stacker ST1. Then, the controlling section C4 ejects the final page of the copy in a mid-course of its creation under the currently conducted job to a predetermined tray (the first ejecting tray 210) established and designated as one of the setting conditions of the job (Step S22), and controls the conveyance path switching section 214 so as to eject the initial page of the next copy onto the second ejecting tray 211 of the copy stacker ST1 established and designated as one of the setting conditions of the test copy job mode (Step S23). After ejecting a number of test copies or a number of test sheets established in advance (normally, one copy or one sheet) onto the second ejecting tray 211 (Step S24: 4: Yes), the currently conducted job enters in a temporal standby state (Step S25).

By inspecting the image quality of the predetermined number of copies ejected onto the second ejecting tray 211, the supervising copy operator (the operator) confirms the finished status of the copy in order to determine whether or not the operation for changing the setting conditions established for the job suspended is necessary.

When determining that the operation for changing the setting conditions is necessary (Step S26: Yes), the operator inputs a correction amount for changing the setting of the job suspended, from the operation displaying section 190 currently displaying a screen corresponding to the test copy job mode (Step S27). Incidentally, instead of inputting the correction amount, it is also applicable to establish a new condition.

After inputting the correction amount, the number of copies or the number of sheets with respect to the test copy, the supervising copy operator input instruction information for commencing the test copy operation from the operation displaying section 190 to create the test copy under the corrected conditions (Step S28).

When a number of copies or a number of sheets established in advance for the test copy are ejected onto the second ejecting tray 211 (Step S29: Yes), the mechanical operations in the system is deactivated (Step S30).

By inspecting the image quality of the test copy ejected onto the second ejecting tray 211, the supervising copy operator confirms the finished status of the copy to determine whether or not further correction is needed (Step S26). When determining that further correction is needed (Step S26: Yes), the operations to be performed in Steps 27-30 are repeatedly performed again, while, when determining that further correction is not needed (Step S26: No), the supervising copy operator determines whether or not the created test copy should be included in the number of copies or the number of sheets established for the job suspended, and then, inputs instruction information from the screen displayed on the operation displaying section 190, which currently displays a message for urging the input of the determined result (Step S31).

When determining that the created test copy should be included (Step S31: Yes), the supervising copy operator inputs a number of copies or a number of sheets to be included form the operation displaying section 190 currently displaying a message for urging the input operation (Step S32), and further, inputs instruction information for resuming the implementation of the job currently suspended from the operation displaying section 190 (Step S33). When determining that the created test copy should not be included (Step S31: No), the supervising copy operator skips the step of inputting a number of copies or a number of sheets to be included (Step S32), and inputs instruction information for resuming the implementation of the job currently suspended from the operation displaying section 190 (Step S33).

When the job suspended is resumed, the controlling section C4 of the copy stacker ST1 switches the conveyance path switching section 214 so that the copy P1 to be created in the job resumed is ejected onto the first ejecting tray 210, which was established as the ejecting destination in the job suspended (Step S34).

FIG. 11 shows a flowchart of a test copy processing in which two kinds of instruction information for shifting to the test copy mode are employed.

In the flowchart shown in FIG. 11, Step S21 shown in FIG. 10 is replaced by Step S35 and Step S36. Other steps to be shown in FIG. 11 are the same as those in the FIG. 10, and therefore, are omitted in FIG. 11.

When the instruction information for shifting to the test copy mode are inputted from the operation displaying section 190 (Step S35: Yes), it enters into Step S22 shown in FIG. 10 so as to conducts the processing already described. Further, even if the instruction information for shifting to the test copy mode are not inputted from the operation displaying section 190 (Step S35: No), when a current number of copies or sheets of the copy P1 created by implementing the job reaches to the number of copies or the number of sheets established in advance for shifting from the normal copy job mode to the test copy job mode, the normal copy job mode is automatically shifted to the test copy job mode (Step S36: Yes).

According to the processing flow mentioned in the above, it becomes possible for the supervising copy operator to confirm the image quality of the copy P1 not only for every time when the predetermined number of copies or sheets are created, but also any timing necessary for the supervising copy operator irrespective of the predetermined number of copies or sheets.

Although the term of “copy” is employed in the descriptions in the foregoing, it is apparent that the same effects as mentioned in the above can be obtained even if the term of “copy” is replaced by the term of “print output”.

### Third Embodiment

Referring to the drawings, the third embodiment of the present invention will be detailed in the following. However, the scope of the present invention is not limited to the examples shown in the drawings.

Incidentally, since the configuration of the apparatuses, such as the high-speed image forming apparatus GS, the paper feeding apparatus SP and the copy stackers ST1, ST2, that constitute the high-speed image forming system SY, are substantially the same as those shown in FIGS. 5-8, the explanations of them will be omitted in the following.

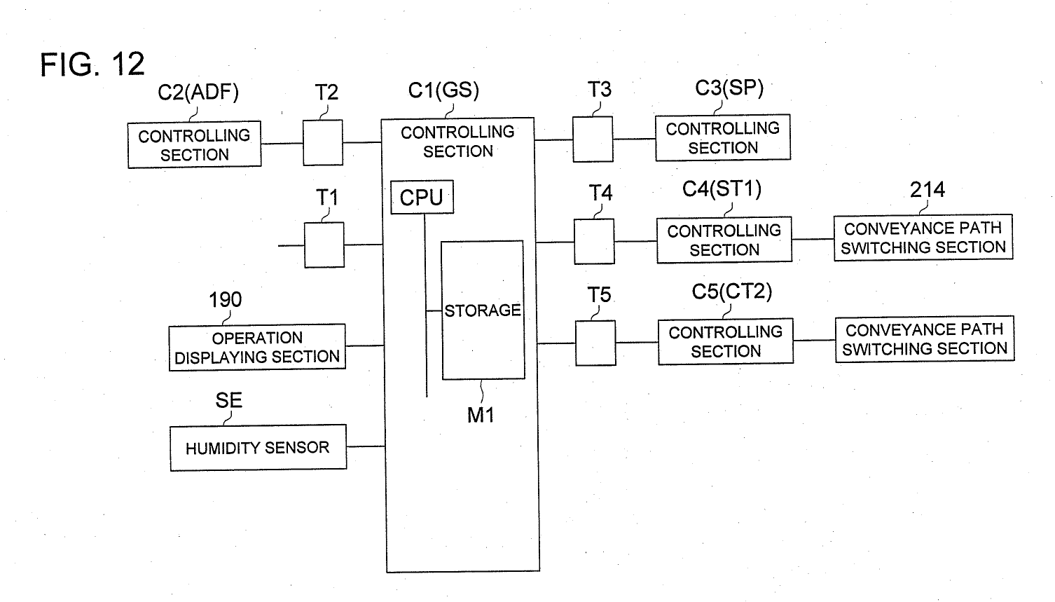

FIG. 12 shows a block diagram of a controlling configuration of a high-speed image forming system SY embodied as the third embodiment of the present invention. As shown in FIG. 12, in the high-speed image forming system SY of the third embodiment, a humidity sensor SE, which is disposed at a predetermined position inside the high-speed image forming apparatus GS so as to measure humidity inside the high-speed image forming apparatus GS, is coupled to the controlling section C1.

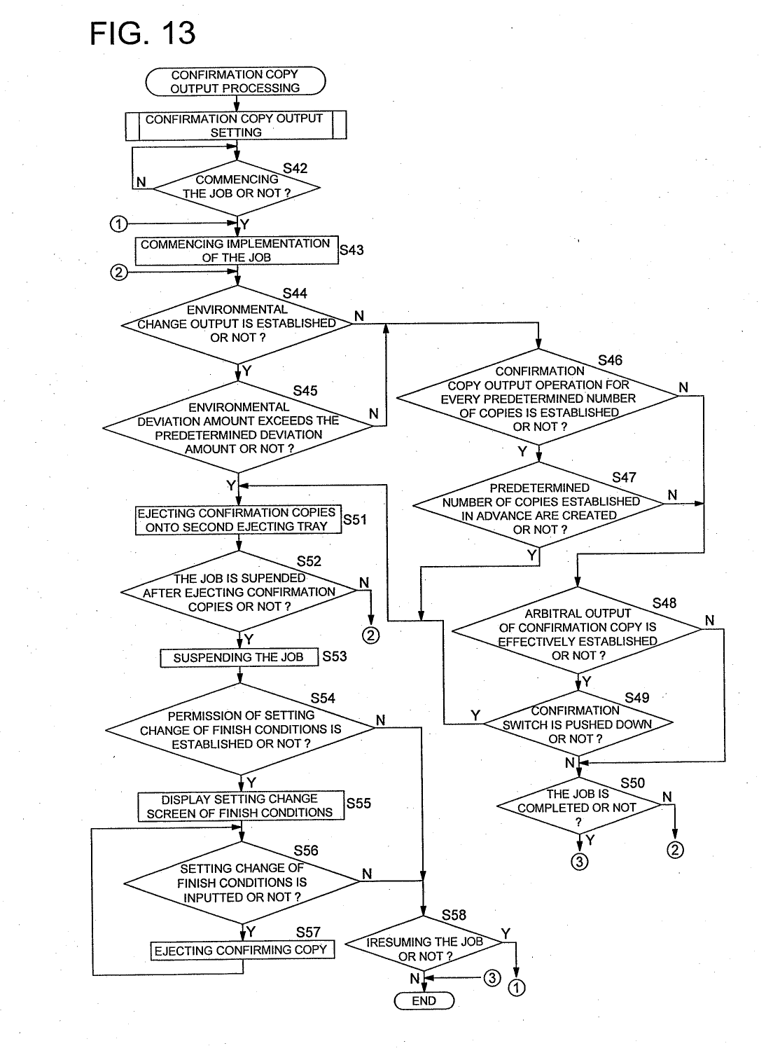

FIG. 13 shows a flowchart of a confirmation copy output processing to be implemented under the controlling actions performed by the controlling section C1 of the high-speed image forming system SY embodied in the present invention. The confirmation copy output processing is implemented when the output setting of the confirmation copy is designated by pushing down the confirmation copy output setting button, which is displayed on the fundamental screen (not shown in the drawings) of the operation displaying section 190. Incidentally, the job performed in the high-speed image forming system SY embodied in the present invention is to continuously conduct copying operations for a plurality of sheets and stack them onto the first ejecting tray 210. Further, the confirmation copy is defined as a copy for confirming the finished state of the image formed during the implementation of the job.

Initially, the controlling section C1 conducts the confirmation copy output setting corresponding to the input from the operation displaying section 190 (Step S41). For instance, in response to the push-down action of the confirmation copy output button displayed on the operation displaying section 190, the controlling section C1 controls the operation displaying section 190 so as to display a screen for inputting instruction information with respect to a confirmation output (proofing output) for confirming the finished status of the image during the execution of the image forming job (for instance, a confirmation output setting screen 191 and a confirmation copy output detail setting screen 192), and establishes the instruction information inputted from the screen as the confirmation copy output information.

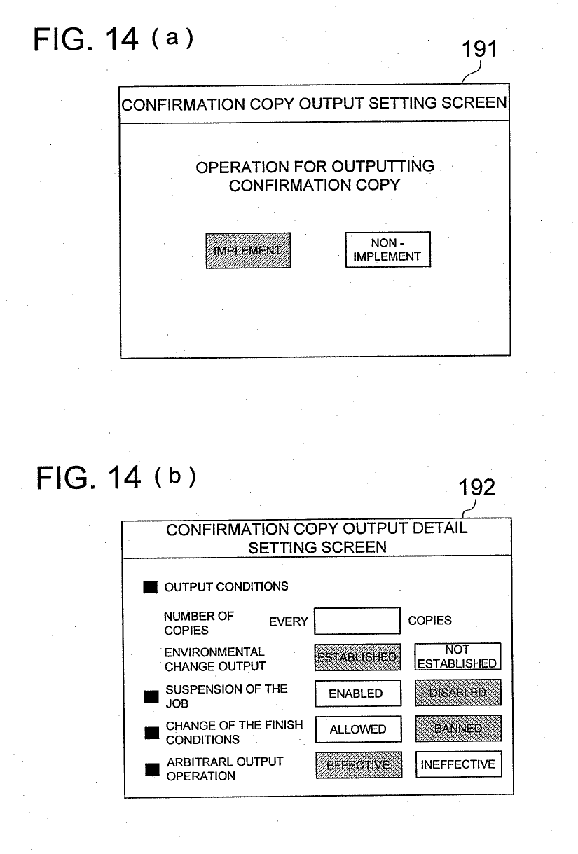

FIG. 14(a) shows an example of the confirmation output setting screen 191, while FIG. 14(b) shows an example of the confirmation copy output detail setting screen 192. As shown in FIG. 14(a), an “implement” button for instructing the implementation of the confirmation copy output and a “non-implement” button for instructing the non-implementation of the confirmation copy output are provided in the confirmation output setting screen 191. When the “implement” button, displayed on the confirmation output setting screen 191, is pushed down, the confirmation copy output detail setting screen 192 is displayed. As shown in FIG. 14(b), the confirmation copy output detail setting screen 192 is used for inputting various kinds of detailed information, such as confirmation copy output conditions, etc. For instance, there are provided in the confirmation copy output detail setting screen 192 a blank for inputting a prescribed number of copies when outputting the confirmation copy for every time when the prescribed number of copies of the copy P1 are completed by executing the job, a selecting button for selecting whether or not the confirmation copy should be outputted when an environmental deviation amount (for instance, humidity) in the high-speed image forming apparatus GS exceeds the predetermined deviation amount (for instance, 20%), another selecting button for selecting whether or not the job should be suspended after outputting the confirmation copy, still another selecting button for selecting whether a setting change of the finish conditions is allowed or banned after the job is suspended, still another selecting button for selecting whether an arbitrarily outputting operation during the implementation of the job is allowed or banned, etc. The instruction information inputted into the blank and instructed by the various kinds of selecting buttons are inputted into the controlling section C1, and then, are established as the confirmation copy output information by the controlling section C1. Incidentally, by setting the prescribed number of copies at zero, it can be instructed to the controlling section C1 that the output operation for every prescribed number of copies is disabled.

When the instruction for commencing the job (the job start instruction) is inputted from the operation displaying section 190 (Step S42) after the confirmation copy output settings are established, the controlling section C1 notify the controlling sections C2, C3, C4, C5 of the job start instruction so as to commence the implementation of the job by controlling the various sections (Step S43). Next, referring to the confirmation copy output information, the controlling section C1 determines whether or not the environmental change output is established. When determining that the environmental change output is established (Step S44: Yes), the controlling section C1 determines whether or not the environmental deviation amount (here, humidity) detected by the humidity sensor SE exceeds the predetermined deviation amount (here, 20%). When determining that the environmental deviation amount exceeds the predetermined deviation amount (Step S45: Yes), the controlling section C1 enters into the processing of Step S51. When determining that the environmental change output is not established in Step S44 (Step S44: No), or when determining that the environmental deviation amount does not exceed the predetermined deviation amount (Step S45: No), the controlling section C1 enters into the processing of Step S46.

In Step S46, referring to the confirmation copy output information, the controlling section C1 determines whether or not the confirmation copy output operation for every predetermined number of copies is established. When determining that it is established (Step S46: Yes), the controlling section C1 determines whether or not the output timing of the confirmation copy for every predetermined number of copies arrives, namely, whether or not the predetermined number of copies established in advance are created after the commencement of the job or after ejecting the previous copy onto the second ejecting tray 211. When determining that the predetermined number of copies established in advance are already created (Step S47: Yes), the controlling section C1 enters into the processing of Step S51. On the other hand, when determining that the confirmation copy output operation for every predetermined number of copies is not established in Step S46, or when determining that the predetermined number of copies established in advance are not created yet after the commencement of the job or after ejecting the previous copy onto the second ejecting tray 211 in Step S47, the controlling section C1 enters into the processing of Step S48.

In Step S48, referring to the confirmation copy output information, the controlling section C1 determines whether or not the arbitral output of the confirmation copy is effectively established. When determining that it is effectively established (Step S48: Yes), the controlling section C1 determines whether or not the confirmation switch, which is disposed at the operation displaying section 190 for instructing the output of the confirmation copy during the implementation of the job, is pushed down. When determining that the confirmation switch is pushed down (Step S49: Yes), the controlling section C1 enters into the processing of Step S51. On the other hand, when determining that the arbitral output of the confirmation copy is established as ineffective in Step S48, or when determining that the confirmation switch is not pushed down (Step S49: No), the controlling section C1 determines whether or not the job is completed. When determining that the job is not completed (Step S50: No), the controlling section C1 returns to the processing of Step S44. When determining that the job is completed (Step S50: Yes), the controlling section C1 finalizes the confirmation copy output control processing.

In Step S51, the controlling section C1 transmits a switching instruction information to the controlling section C4 so that the controlling section C4 controls the conveyance path switching section 214 to change the conveyance path. According to this operation, the predetermined number of sheets of copy P1, on which the images are already formed, (normally, a part of copy, or one sheet) are ejected onto the second ejecting tray 211 (Step S51). Accordingly, the confirmation copy is outputted. Incidentally, after ejecting the predetermined number of sheets of copy P1 onto the second ejecting tray 211, the conveyance path is returned to the original state.

Successively, referring to the confirmation copy output information, the controlling section C1 determines whether or not the operation for suspending the job after the output operation of the confirmation copy is completed is established. When determining that it is not established (Step S52: No), the controlling section C1 returns to the processing of Step S44. When determining that the operation for suspending the job after the output operation of the confirmation copy is completed is established (Step S52: Yes), the controlling section C1 controls the section concerned so as to suspend the job currently implemented (Step S53). Successively, referring to the confirmation copy output information, the controlling section C1 determines whether or not the permission of the setting change of the finish conditions is established. When determining that it is not established (Step S54: No), the controlling section C1 enters into the processing of Step S58. When determining that the permission of the setting change of the finish conditions is established (Step S54: Yes), the controlling section C1 controls the operation displaying section 190 to display the setting change (correction) screen of the finish conditions (Step S55), and then, when the setting change of the finish conditions is inputted from the operation displaying section 190 (Step S56: Yes), the controlling section C1 controls the sections concerned so as to eject the correction confirming copy onto the second ejecting tray 211 (Step S57) and returns to Step S56. When the instruction for excluding the setting change of the finish conditions is inputted from the operation displaying section 190 in Step S56 (Step S56: No), and further, the instruction for resuming the job is inputted from the operation displaying section 190 (Step S58: Yes), the controlling section C1 returns to Step S56 so as to resume the job temporarily stopped. When the instruction for not resuming the job is inputted from the operation displaying section 190 (Step S58: No), the confirmation copy output control processing is finalized.

As described in the foregoing, according to the high-speed image forming system SY embodied as the third embodiment, since the confirmation output setting screen 191 and the confirmation copy output detail setting screen 192 are displayed before the commencement of the job, it becomes possible for the operator to input the instruction information, such as the output conditions of the confirmation copy (whether the confirmation copy is outputted for every predetermined number of copies, or at the time of the environmental change, etc.), whether the arbitral output during the implementation of the job is enabled or disabled, whether or not the job should be temporarily stopped after outputting the confirmation copy, whether or not the setting change of the finish conditions should be allowed, etc. Then, corresponding to the instruction information inputted by the operator, the operation for outputting the confirmation copy is conducted during the implementation of the job.

Accordingly, since it becomes possible for the operator to freely customize the output conditions of the confirmation copy during the implementation of the job, the operator can periodically confirm the finished state of the image for every predetermined number of copies desired, confirm the finished state of the image when the environmental change occurs in the high-speed image forming apparatus GS and confirm the finished state of the image at any time when the operator wishes to confirm. In addition, it also becomes possible for the operator to temporarily stop the job or to change the finish conditions after outputting the confirmation copy, as needed.

Incidentally, the aforementioned descriptions in regard to the third embodiment explain merely a preferable example of the high-speed image forming system SY embodied in the present invention. Accordingly, the scope of the present invention is not limited to the above.

For instance, although the operator can establish the predetermined number of copies, for every which the confirmation copy is to be outputted, from the operation displaying section 190 as the output condition of the confirmation copy in the third embodiment, it is also applicable that the operator can establish a predetermined number of sheets, for every which the confirmation copy is to be outputted, and the controlling section C1 transmits the switching instruction information for switching the conveyance path at every time when the creation of the predetermined number of sheets is completed, so as to eject the copy P1 onto the second ejecting tray 211. Further, it is also applicable that an order of copy division, among the copy divisions to be created in the job, at which the copy is to be outputted as the confirmation copy; a page number, among each of the confirmation copies, at which the sheet is to be outputted as the confirmation copy; and an order of sheet, among the total number of sheets to be created in the job, at which the sheet is to be outputted as the confirmation copy, are made to be settable, so that the controlling section C1 transmits the switching instruction information for switching the conveyance path to the controlling section C4 when the copies currently created in the job reach to the predetermined numbers of copies, pages and sheets, so as to eject the copy P1 onto the second ejecting tray 211.

Further, although the third embodiment is so constituted that there are two ejecting trays of the copy stackers ST1, ST2, and the confirmation copy is ejected onto the second ejecting tray 211, it is also applicable that the ejecting destination is settable in the case that a plurality of ejecting trays are provided.

Still further, although the humidity change is exemplified as the environmental change in the third embodiment, the scope of the environmental change is not limited to the above. It is also applicable that another deviation amount, such as a temperature change, etc., is employed as the environmental change.

Still further, it is also applicable that the operator can select and input whether or not the copy P1, ejected onto the second ejecting tray 211 when outputting the confirmation copy, should be included into the total number of copies to be created in the image forming job

Yet further, with respect to the detailed configuration and the detailed operations of the high-speed image forming system SY, disclosed embodiments can be varied by a skilled person without departing from the spirit and scope of the present invention.

According to the present invention described in the foregoing, the following effects can be attained.
(1) It becomes possible for the operator to confirm the finished state of the image, formed on the sheet, any time as needed.
(2) Even if the image forming system is so constituted that the papers, on which the images are already formed and which are stacked onto the stacking section, are shielded from the external section, it becomes possible for the operator to confirm the finished state of the image any time when the operator wishes to confirm the finished state of the image formed on the paper.
(3) It becomes possible for the operator to confirm the finished state of the image any time when the operator wishes to confirm the finished state of the image formed on the paper during the implementation of the image forming job.
(4) It becomes possible to prevent such a deficiency that a defected copy division, in which a certain page, constituting the copy division concerned, is lacked since the lacked page has been ejected onto the ejecting section, is mingled with the copies stacked on the stacking section.
(5) It becomes possible to eject a predetermined number of copies or sheets bearing formed images in such a manner that the operator can pick up them by hand in order to confirm the finished state of the images.
(6) It becomes possible for the operator to confirm the finished state of the images, every time when the operator wishes to confirm the finished state of the images, or when the outputting conditions, desired by the operator, are fulfilled during the implementation of the image forming job.
(7) It becomes possible for the operator to periodically confirm the finished state of the images for every predetermined number of copies or sheets, desired by the operator, during the implementation of the image forming job.
(8) It becomes possible for the operator to confirm the finished state of the images at the time when an environmental deviation in the image forming section exceeds the predetermined amount.
(9) Since the image forming job can be suspended after the finished state of the formed images is confirm, it becomes possible to suppress the waist of paper sheets outputted erroneously.
(10) It is possible for the operator to designate in advance whether the image forming job should be continued or suspended after confirming the finished state of the images.
(11) When the operator confirms that the image quality at the time of the commencement of the image forming job is not maintained, as a result of confirming the finished state of the images during the implementation of the image forming job, it becomes possible for the operator to correct the image quality by changing the finishing conditions of the images.
(12) It becomes possible to confirm the setting contents after the finishing conditions of the images are changed.
(13) It becomes possible to continuously stack the recording materials onto the stacking section after the resumption of the image forming job is instructed.
(14) It becomes possible to determine whether or not a number of recording materials to be ejected onto the ejecting section should be included in the total number of the copies to be outputted, resulting in an improvement of user-friendliness of the apparatus.
(15) It becomes possible for the operator to establish a number of copies to be included in the total number of output copies among the recording materials to be ejected onto the ejecting section, resulting in an improvement of user-friendliness of the apparatus.

### Forth Embodiment

Referring to the drawings, the fourth embodiment of the present invention will be detailed in the following. However, the scope of the present invention is not limited to the examples shown in the drawings. Further, the following descriptions do not limit the scope of technical field or the meaning of the terms recited in the claims.

Hereinafter, a confirmation image is defined as an image for confirming a position of the image relative to the sheet and for confirming a quality of the image, a confirmation image outputting sheet is defined as a sheet bearing the confirmation image and confirmation image information is defined as information (data) representing the confirmation image.

Further, the term of “job” in a narrow sense indicates at least a unit of image information. For instance, the “job” indicates an image information unit or a group of a plurality of image information units read by a document reading device. Further, the “job” indicates an image information unit or a group of a plurality of image information units read from an external section trough a communication network, such as the LAN (Local Area Network), the Internet, etc.

Still further, the term of “job” in a broad sense indicates a print outputting process performed on the basis of the image information unit or the group of the plurality of image information units mentioned in the above. Still further, the term of a “division of number of copies of the job” indicates a division of a plurality of units constituting the job concerned.

Hereinafter, unless otherwise specified, the term of “job” indicates a job in a narrow sense.

Further, the term of “job image information” indicates information (data) representing the image in regard to the job concerned. While, the term of “job information” indicates information of output conditions in regard to the job concerned.

Initially, the configuration and operations of the image forming apparatus embodied in the present invention will be detailed in the following.

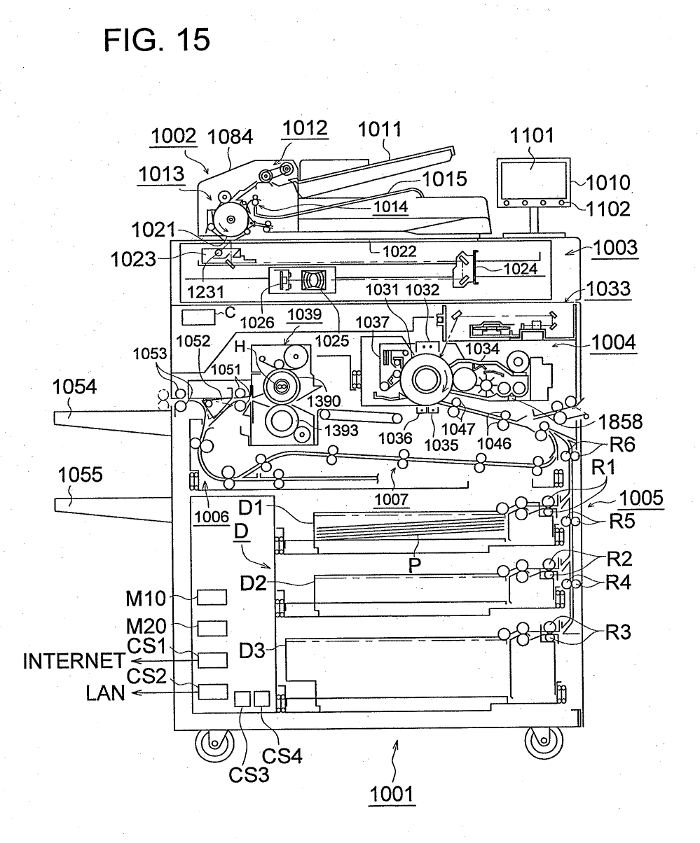

FIG. 15 shows a cross sectional configuration of an example of the image forming apparatus embodied in the present invention.

An image forming apparatus 1001 is provided with: an automatic document feeder 1002 for picking up a document one by one from a group of stacked document sheets in regard to a job concerned so as to convey it to an image reading position, and then, to eject it; an image reading section 1003 for reading the image residing on the document sheet at the image reading position; an image forming section 1004, serving as an image forming section for forming a toner image onto a paper sheet, based on image data read by the image reading section 1003; a high-volume paper feeding unit D for picking up a paper sheet having a predetermined size one by one from a paper feeding tray to feed the paper sheet; a feeding section 1005 for conveying and feeding the paper sheet picked up by the high-volume paper feeding unit D to a transferring position of the toner image; a paper reversing/ejecting and re-feeding section 1006 for reversing the paper sheet bearing the toner image and/or re-feeding it to the transferring position of the toner image; a reversing conveyance section 1007 for reversing the paper sheet; an operational panel 1010 that is constituted by a touch panel, operation switches, etc., so that the operator can input the job information and information of the output conditions in regard to the confirmation image, and for displaying a current status of the apparatus; an internet communication section CS1 for communicating with the external server, etc., through the Internet; a LAN communication section CS2 for communicating with the external server and another image forming apparatus, through the LAN (Local Area Network); a paper-feeding apparatus communication section CS3 for communicating with a paper feeding apparatus 1009; a post-processing apparatus communication section CS4 for communicating with a post-processing apparatus 1008; a controlling section C that includes a CPU, a RAM (Random Access Memory) M10 serving as a rewritable memory coupled to a backup battery, a ROM (Read Only Memory) M20 serving as a non-volatile memory in which controlling programs for executing the image forming operations and programs in regard to the communication controlling operations, etc., are stored in advance, and various kinds of interface members, in order to control the abovementioned sections from the automatic document feeder 1002 to the post-processing apparatus communication section CS4; etc.

As detailed later, it is applicable that each of the operational panel 1010, the Internet communication section CS1 and the LAN communication section CS2 has a function of a confirmation image information acquiring section. Further, the operational panel 1010 has functions of an output-time designating section for designating a time when outputting the confirmation image based on the confirmation image information, an image information selecting section for selecting either the job image information or the test-chart image information, an output page selecting section for selecting a page to be outputted as the confirmation image and a job suspension selecting section for selecting whether or not the output operation of the job image should be suspended.

Next, the operations in the image forming apparatus 1001 will be detailed in the following. The image forming apparatus 1001 is activated when the operator inputs the job information, etc., and an instruction for activating the image forming operation from the operational panel 1010. Successively, in the automatic document feeder 1002 of the image forming apparatus 1001, a document separating roller 1012 separates a document sheet one by one from a plurality of document sheets (not shown in the drawings) stacked on a document stacking tray 1011, and a document sheet conveyance section 1013 conveys the separated document sheet to the image reading position.

The document image reading position is disposed below the document sheet conveyance section 1013 so that the image on the document, serving as a job image, can be read through a slit 1021 of image reading section 1003.

The document sheet whose image is already read is ejected onto a document ejecting tray 1015 by a document ejecting rollers 1014.

Further, the image forming apparatus 1001 is so constituted that the document can be directly put on a platen glass 1022 to conduct the copy operation.

The image reading section 1003 is constituted by a lamp 1231 for irradiating light onto the document through the slit 1021, a first mirror unit 1023 and a second mirror unit 1024 for reflecting light reflected from the document, a focusing lens 1025 for focusing the reflected light onto an image capturing element, and a CCD (Charge Coupled Device) 1026, shaped in a line, for photo-electronically converting the photo image projected by the focusing lens 1025 to analogue image signals.

The analogue image signals, generated by the photo-electronic converting action conducted in the CCD 1026 and representing the document image, are further converted to digital image data by applying an analogue-to-digital conversion processing after an analogue processing is applied. Then, in an image processing section (not shown in the drawings), appropriate image processing operations, such as a shading correction, a filter processing, a y correction, etc., are applied to the digital image data as needed to generate image information, which are temporarily stored in the RAM M10.

Incidentally, it is also applicable that the job image information and its job information are acquired from the external server or a personal computer (hereinafter, referred to as a PC) through the Internet by the internet communication section CS1. Further, it is also applicable that the job image information and its job information are acquired from the other image forming apparatus, the external server, etc., through the LAN by the LAN communication section CS2.

According to the above, it becomes possible to acquire the job image information and its job information from a PC, a server, a scanner, etc., equipped on another floor or in a remote site.

The image forming section 1004, in which the image forming operations are conducted by employing the electro-photographic process, is provided with: a photoreceptor drum 1031 having a photoconductive and photosensitive layer serving as a image bearing member on its circumferential surface; a charging device 1032 for uniformly charging the circumferential surface of the photoreceptor drum 1031; a laser image writing system 1033 serving as an exposing device, which is operated on the basis of the image data after image processing, for exposing the photoreceptor drum 1031 so as to form an electrostatic latent image on its circumferential surface; a developing unit 1034 for developing the electrostatic latent image formed on the photoreceptor drum 1031 with toner so as to form a toner image on it; a transferring electrode 1035 for transferring the toner image onto the paper sheet; a discharging device 1036 for conducting an AC corona discharging action from the reverse side of the paper sheet on which the toner image is transferred, so as to urge the separating action of the paper sheet from the photoreceptor drum 1031; a cleaning device 1037 for cleaning the circumferential surface of the photoreceptor drum 1031 after the transferring operation is completed; etc.

A fixing device 1039 includes a heat source H, a heating roller 1390 independently rotating around the heat source H and a pressing roller 1393 rotating while press-contacting the heating roller 1390. A fix ejecting roller 1051, a switching member 1052 and an ejecting roller 1053 for ejecting the paper sheet outside the apparatus, which serve as structural elements of the paper reversing/ejecting and re-feeding section 1006, are disposed downstream from the fixing device 1039.

The image forming operation, to be conducted by the image forming section 1004 and the fixing device 1039, is achieved by conducting the steps of: charging the circumferential surface of the photoreceptor drum 1031, driven to rotate in a direction shown by the arrow by a drum driver (not shown in the drawings), by activating the charging device 1032; forming an electrostatic latent image corresponding to the job image information by applying the dot-exposing actions performed by the laser image writing system 1033; developing the electrostatic latent image with toner to form a toner image by employing the developing unit 1034; transferring the toner image onto the paper sheet P fed by starting the rotation of registration rollers 1046 serving as the second paper feeding device, by applying the actions of the transferring electrode 1035; and fixing the toner image onto the paper sheet P by applying heat and pressure onto the paper sheet P in the fixing device 1039.

Further, the high-volume paper feeding unit D is provided with feeding units D1-D3 each of which is capable of accommodating a large amount of paper sheets, so that a paper sheet P, having a predetermined size and being a predetermined kind, is fed to the transferring position by one of pairs of conveyance rollers R1, R2, R3, R4, R5 (hereinafter, also referred to as conveyance rollers R1, R2, R3, R4, R5) from any one of the feeding units D1-D3, selected corresponding to the job information.

The feeding section 1005, serving as a conveying section for feeding the paper sheet P from the high-volume paper feeding unit D to the image forming section 1004, is provided with a pair of conveyance rollers R6 (hereinafter, also referred to as conveyance rollers R6), the registration rollers 1046, pre-transferring rollers 1047, etc., so as to feed the paper sheet P fed from the high-volume paper feeding unit D to the image forming section 1004.

Incidentally, it is also applicable that a conventional paper feeding apparatus, which is disposed upstream the image forming apparatus 1001 and capable of accommodating a further large amount of paper sheets (not shown in the drawings), is coupled to the image forming apparatus 1001, so as to feed a paper sheet P, having a predetermined size and being a predetermined kind, from a predetermined paper feeding tray under the communication with the image forming apparatus 1001.

The paper reversing/ejecting and re-feeding section 1006 reverses or ejects the paper sheet P having a fixed toner image and feeds the paper sheet P back to the image forming section 1004 according to the duplex image forming mode. In normal mode, the paper sheet P ejected by a fixing eject rollers 1051 is ejected and stacked onto the a first high-volume stacking tray 1054 through the upper surface of a switching member 1052 by activating a paper ejecting rollers 1053.

Incidentally, the first high-volume stacking tray 1054 is equipped as an upper stage tray disposed at such a position that the upper surface of the tray can be seen by the operator's visual observation from the upper side of the image forming apparatus 1001.

It is also applicable that each of the first high-volume stacking tray 1054 and a second high-volume stacking tray 1055 is independently driven to move in a vertical direction shown in FIG. 15 by a moving driver (not shown in the drawings), and, in a normal mode, the paper sheet is ejected and stacked onto the first high-volume stacking tray 1054, while, for instance, the confirmation copy sheet is ejected and stacked onto the second high-volume stacking tray 1055 by moving the first high-volume stacking tray 1054 and the second high-volume stacking tray 1055.

Further, it is also applicable that a conventional paper stacking apparatus, which is disposed downstream the image forming apparatus 1001 and capable of stacking a large amount of paper sheets (not shown in the drawings), is coupled to the image forming apparatus 1001, so as to stack a predetermined paper sheet P ejected from image forming apparatus 1001 onto a predetermined tray under the communication with the image forming apparatus 1001.

The controlling operations of the image forming apparatus 1001 will be detailed in the following.

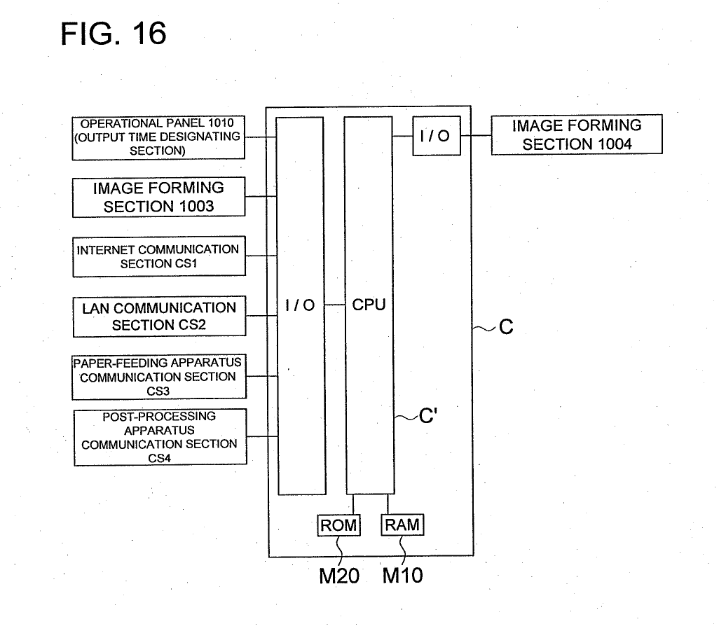

FIG. 16 shows a block diagram of the first controlling mode of the image forming apparatus 1001.

Referring to FIG. 15 and FIG. 16, the confirmation-image output controlling operation of the image forming apparatus 1001 will be detailed in the following.

The operational panel 1010, having a touch panel, is provided with an inputting section 1102 for inputting the job information, etc., (for instance, paper size information) by the operator, and a displaying section 1101 for displaying the status, etc. of the image forming apparatus 1001. Communicating the information with the controlling section C, the information inputted from the inputting section 1102 are further inputted into the controlling section C, and the images, based on the displaying information sent form the controlling section C in regard to the confirmation image output operation, are displayed on the displaying section 1101.

Further, the operational panel 1010 also serves as an output time designating section for designating the time when the confirmation image should be outputted. Incidentally, it is also applicable that the output time designating section is separately provided.

The image reading section 1003, serving as a confirmation image reading section, reads a document image, being one of confirmation images, so as to input them into the controlling section C as the job image information.

Each of the Internet communication section CS1 and the LAN communication section CS2, serving as a confirmation image reading section, receives the job image information being one of confirmation images and the job information from the external server or the personal computer (PC) through the Internet or the LAN, so as to input them into the controlling section C as the job image information and the job information.

The paper-feeding apparatus communication section CS3 that is disposed in the image forming apparatus 1001 for communicate with the paper feeding apparatus 1009 and the post-processing apparatus communication section CS4 that is disposed in the image forming apparatus 1001 for communicate with the post-processing apparatus 1008 are coupled to the paper-feeding apparatus communication section CS3′ of the paper feeding apparatus 1009 and the post-processing apparatus communication section CS4′ of the post-processing apparatus 1008, respectively, specifically to communicate information in regard to the paper sheet with each other. Accordingly, this configuration makes the sequential operation between the image forming apparatus 1001, the paper feeding apparatus 1009 and the post-processing apparatus 1008 possible.

Incidentally, it is applicable that the image forming apparatus 1001 is provided with at least one of the image reading section 1003, the internet communication section CS1 and the LAN communication section CS2.

The RAM M10 serves as a RAM provided with the backup battery. The job image information, the job information, various kinds of information (data), such as confirmation copy image information, etc., inputted from one of the internet communication section CS1 and the LAN communication section CS2, are stored/read into/from the RAM M10.

The programs for controlling image forming operations, the programs in regard to the communication control, image data representing a test chart (for instance, a patch image for density correction, a density chart image for density confirmation), etc. are stored in the ROM M20. A CPU C′ reads them from the ROM M20.

The image forming section 1004 is provided with the photoreceptor drum 1031, the charging device 1032, the laser image writing system 1033, the transferring electrode 1035, the discharging device 1036, the cleaning device 1037, etc. The results detected by sensors equipped in the abovementioned structural elements are inputted into the CPU C′, so that the CPU C′ controls the various kinds of driving devices (for instance, motors and solenoids) so as to conduct the aforementioned image forming operations.

A interface section I/O serves as an interface between input/output devices and the CPU C′, in order to make it possible to input the information into the CPU C′ from the input/output devices, and to make it possible to drive the input/output devices under the controlling actions conducted by the CPU C′.

Incidentally, the controlling section C of the image forming apparatus 1001 is constituted by the CPU C′, the RAM M10, the ROM M20, the interface section I/O, etc.

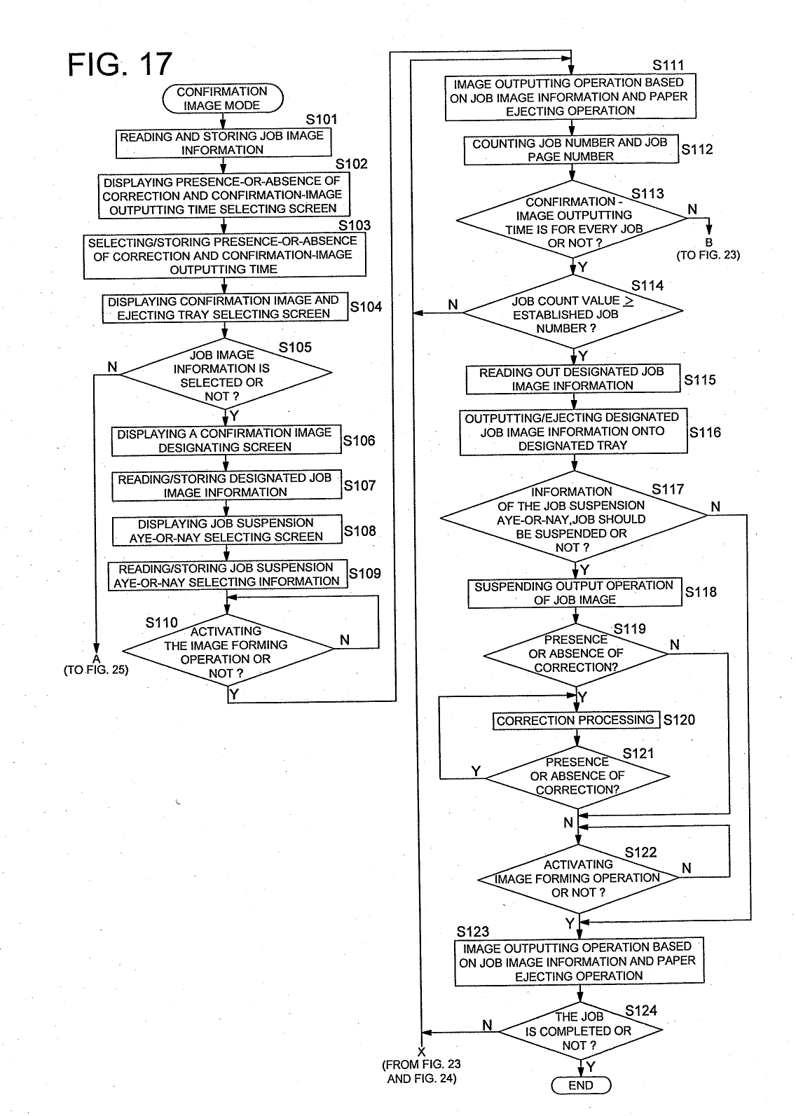

FIG. 17 shows a flowchart (first page) of a controlling mode of the image forming apparatus 1001 embodied in the present invention.

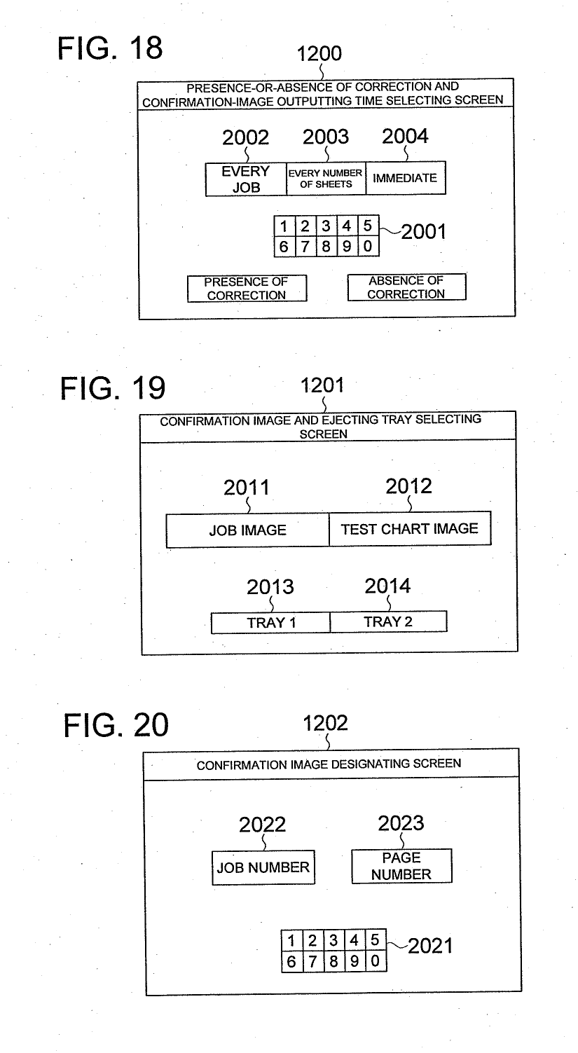

FIG. 18 shows an explanatory schematic diagram of an example of a confirmation-image outputting time selecting screen for selecting a time when outputting the confirmation image.

FIG. 19 shows an explanatory schematic diagram of an example of a confirmation-image selecting screen for selecting the confirmation image.

FIG. 20 shows an explanatory schematic diagram of an example of a job image designating screen for designating a specific job image to be employed as the confirmation image among various kinds of job images.

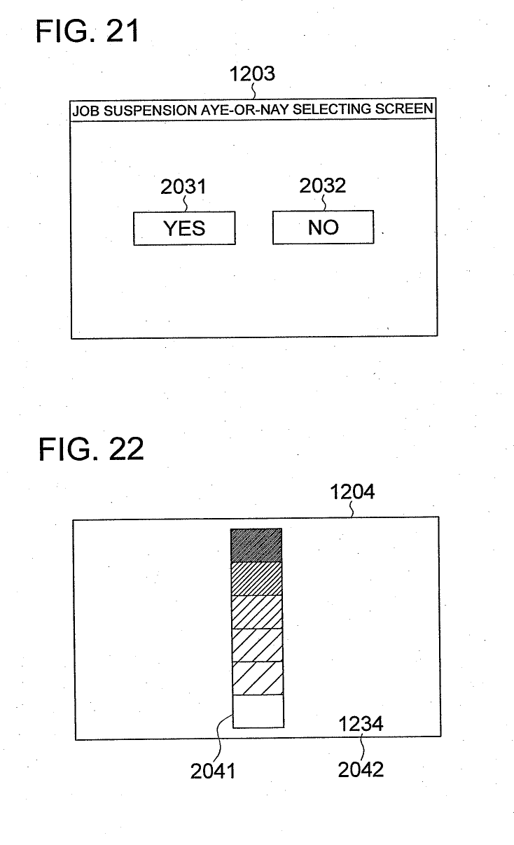

FIG. 21 shows an explanatory schematic diagram of an example of a selecting screen for selecting whether or not the job should be suspended at the time when outputting the confirmation image.

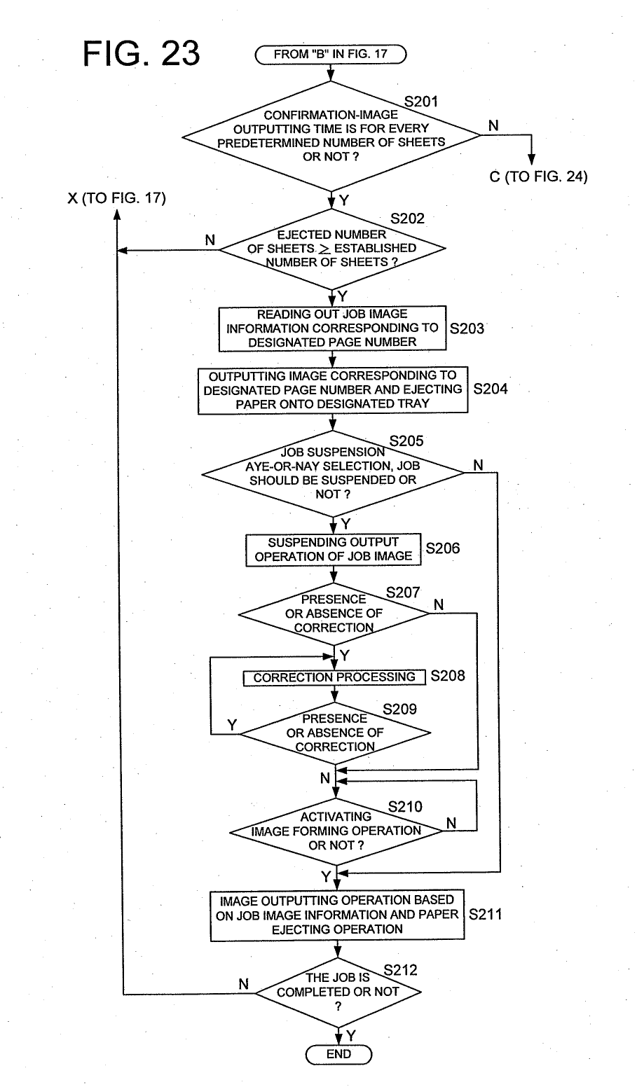

FIG. 22 shows a flowchart (second page) of a controlling mode of the image forming apparatus 1001 embodied in the present invention.

FIG. 23 shows a flowchart (second page) of a controlling mode of the image forming apparatus 1001 embodied in the present invention.

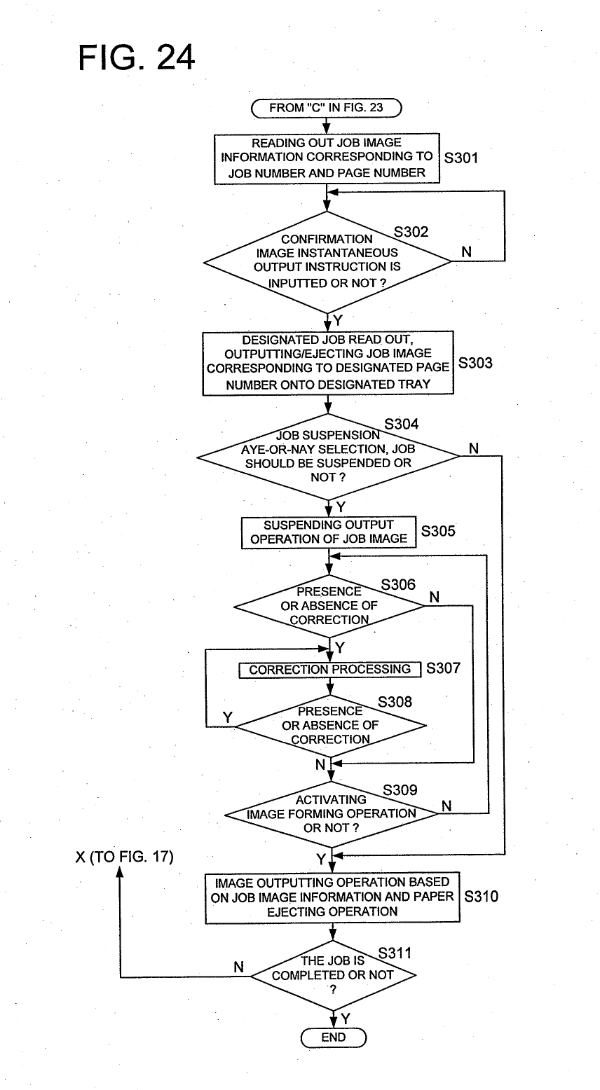

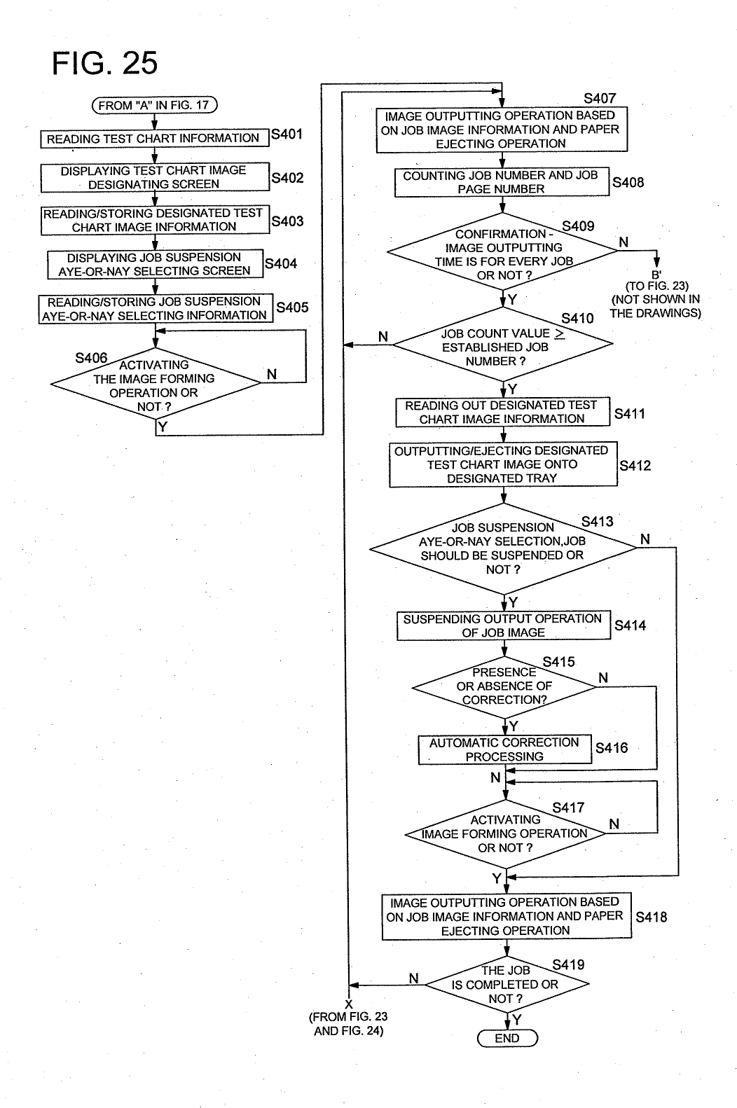

FIG. 24 shows a flowchart (third page) of a controlling mode of the image forming apparatus 1001 embodied in the present invention.

FIG. 25 shows a flowchart (fourth page) of a controlling mode of the image forming apparatus 1001 embodied in the present invention.

Referring to FIGS. 17-25, the flowchart of the controlling mode for outputting the confirmation image in the image forming apparatus serving as the fourth embodiment of the present invention will be detailed in the following.

In the confirmation image mode shown in FIG. 17, the image reading section 1003 reads a job image (document image) to generate job image information, and then, the job image information are stored into the RAM M10 (Step S101). When handling a plurality of jobs, job numbers are attached to them in order of reading, and page numbers are attached to plural image information sets included in one of the jobs in order of reading (for instance, represented as job image information of Job “N”, Page “n”).

Further, it is also applicable that the job image information can be inputted from the external server or the personal computer through the internet communication section CS1 or the LAN communication section CS2.

The operator selects whether or not the correction should be conducted by employing the confirmation screen for selecting outputting time of the confirmation image. The information in regard to a presence-or-absence of correction and confirmation-image outputting time selecting screen are read from the ROM M20, so as to display the presence-or-absence of correction and confirmation-image outputting time selecting screen 1200 (refer to FIG. 18) onto the displaying section 1101 (Step S102).

Among the outputting times of an every job box 2002, an every number of sheets box 2003 and an immediate key 2004, the information contents and the information of presence or absence of the correction, both established by the operator, are read and stored into the RAM M10 (Step S103).

Concretely speaking, either a number of jobs inputted into the every job box 2002 (for instance, 10 jobs), a number of sheets inputted into the every number of sheets box 2003 (for instance, 1000 sheets) by using numeral keys 2001 or a push-down operation of the immediate key 2004, is read and stored into the RAM M10. For instance, when setting at 10 jobs, the confirmation image is outputted for every 10 jobs, while, when setting at 1000 sheets, the confirmation image is outputted for every 1000 sheets, and, when pushing down the immediate key, the confirmation image is instantaneously outputted just after a confirmation image outputting key (detailed later) has turned ON.

Information of a confirmation image selecting screen and selecting information of a paper stacking tray onto which the confirmation image is ejected are read from the ROM M20, so as to display a confirmation image and ejecting tray selecting screen 1201 (refer to FIG. 19) onto the displaying section 1101 (Step S104).

The operator determines whether or not the job image information 2011 is selected by using the confirmation image and ejecting tray selecting screen 1201 (Step S105).

The case that the job image information is selected (Step S105: Yes) and the job image is outputted as the confirmation image will be detailed in the following. On the other hand, the case that the job image information is not selected (Step S105: No) and a test chart is outputted as the confirmation image will be detailed later.

When the job image information is selected (Step S105: Yes), information of a confirmation image designating screen for designating the job image are read from the ROM M20, so as to display a confirmation image designating screen 1202 (refer to FIG. 20) onto the displaying section 1101 (Step S106).

The job number inputted into a job number box 2022 (for instance, job “j”) and a page number inputted into a page number box 2023 (for instance, page “j”), by using numeral keys 2021 by the operator, are read, and then, comparing with the job image information attached with the job number and the page number acquired in Step S101, the job image information, corresponding to the job number and the page number read in above, are read and stored into RAM M10 (Step S107). Information of a job suspension aye-or-nay selecting screen when outputting the confirmation image are read from the ROM M20, so as to display a job suspension aye-or-nay selecting screen 1203 (refer to FIG. 20) when outputting the confirmation image onto the displaying section 1101 (Step S108).

Either a YES instruction 2031 or a NO instruction 2032 selected on the job suspension aye-or-nay selecting screen 1203 is read and stored (Step S109).

An operation for activating the image forming operation is waited (Step. S110).

When an operation for activating the image forming operation is turned ON, the image forming operation and the image outputting operation are conducted on the basis of the job image information (Step S111).

Corresponding to the output, the job number and the job page number are counted (for instance, page “j” of job “j”) (Step S112).

The information of confirmation-image outputting time selecting screen selected in Step S102 is read from the ROM M20, in order to determine whether or not it is for every job (Step S113).

When determining that it is for every job (Step S113: Yes), it is determined whether or not the job count value counted in Step S112 is equal to or greater than the job number (numeral) (for instance, job “j”) established and stored in RAM M10 in Step S107 (Step S114).

When determining that the job count value counted is equal to or greater than the job number (Step S114: Yes), the designated job image information corresponding to the job number (for instance, job “j”) and the page number (for instance, page “j”) designated in Step S107 and stored in the RAM M10 are read out (Step S115).

When determining that the job count value counted is smaller (Step S114: No), the process jumps to Step S111, in order to continue the successive output operation.

The images are outputted on the basis of the designated job image information, which are read corresponding to the job number (for instance, job “j”) and the page number (for instance, page “j”) onto the paper sheets, and the paper sheets are ejected onto the paper stacking tray selected by the paper stacking tray selecting screen in Step S104 (for instance, the first high-volume stacking tray 1054 (Step S116)

Incidentally, it is applicable that the paper sheet having the confirmation image of the job output (for instance, page “j” of job “j”) is automatically ejected onto the first high-volume stacking tray 1054 disposed at such a position that the upper surface of the tray can be seen by the operator's visual observation. Further, it is also applicable that the paper ejecting tray employed for the normal job output conducted in Step S111 and Step S120, and the other paper ejecting tray employed for the job output for confirmation image conducted in Step S116 are switched to a different paper stacking tray.

Reading out the information of the job suspension aye-or-nay selection stored in Step S109, it is determined whether or not the job should be suspended (Step S117).

When determining that the job should be suspended (Step S117: Yes), the output operation of the job image is suspended (Step S118).

Incidentally, it is also applicable that the output operation of the job image in regard to the currently implemented job is made to be continued until the whole job is completed, and then, made to be suspended.

When determining that the job should not be suspended (Step S117: No), the process jumps to Step S120, in order to continue the successive output operation of the job image.

It is determined whether or not presence of the correction is stored in Step S103 (Step S119). When determining that presence of the correction is stored, the correction processing is conducted (Step S120).

In the correction processing, a conventional correcting operation with respect to at least one of a image density property and a gradation characteristic (for instance, the correction in regard to the image density property and the gradation characteristic set forth in Tokkaihei 5-14728) is conducted in response to the correction processing activating command inputted by the operator, so as to correct the designated job image outputted in Step S116 based on the correcting conditions, and output the corrected job image.

Incidentally, it is applicable that a page number with respect to the job at the time of output operation is attached to the output image generated by correcting the designated job image based on the correcting conditions.

After the correction processing is completed, it is determined whether or not presence of the correction is still stored (Step S121). When determining that presence of the correction is still stored (Step S121: Yes), the process jumps to Step S120, in order to again conduct the correction processing.

When determining that absence of the correction is stored (Step S119, Step S121: No), the process jumps to Step S122, in order to wait the implementation of the image forming activating operation (Step S122).

Further, when determining that absence of the correction is stored (Step S119, Step S121: No), a colored paper picked up from the paper feeding tray designated by the operator (for instance, the paper feeding tray for accommodating the colored papers) is conveyed and stacked onto the uppermost surface of the currently stacked papers as a making paper indicating before and after of the correcting timing and serving as a bookmark. In this case, when the paper feeding apparatus 1009 is coupled to the image forming apparatus 1001, the colored paper is fed from a predetermined tray in the paper feeding apparatus 1009 by communicating with each other.

When the activating command of the image forming operation turns ON, the image outputting and ejecting operations based on the job image information are resumed (Step S123).

The job image information stored in Step S101 are read out, in order to determine whether or not the job concerned is completed (Step S124).

When the job concerned is not completed (Step S124: No), it is determined that the reading job is not completed, and the process jumps to Step S111 to output the uncompleted job.

When the job concerned is completed (Step S124: Yes), it is determined that the reading job is completed. Then, this program is finalized, and the process jumps to, for instance, a main routine (not shown in the drawings).

Further, when determining that it is not for every job (Step S113: No), the process jumps to Step S201 (refer to FIG. 23), so as to read the information of the confirmation-image outputting time selecting screen selected in Step S102 from the ROM M20 to determining whether or not it is for every predetermined number of sheets (Step S201).

When determining that it is for every predetermined number of sheets (Step S201: Yes), it is determined whether or not the page counted value of the job concerned, counted in Step S112, is equal to or greater than the page number (numeral) (for instance, page “j”) established and stored in the RAM M10 in Step S107 (Step S202).

When determining that the page counted value is equal to or greater than the page number (Step S202: Yes), the page number (for instance, page “j”) designated and stored into the RAM M10 in Step S107, and the designated job image information corresponding to the page number (for instance, page “j”) are read out (Step S203).

When determining that the page counted value is not equal to or greater than the page number (Step S202: No), the process jumps to Step S111 so as to continue the successive outputting operation.

The image is outputted onto the paper sheet, based on the designated job image information read out corresponding to the job number (for instance, job “j”) and the page number (for instance, page “j”), and the paper sheet is ejected onto the paper stacking tray selected by using the paper ejecting tray selecting screen in Step S104 (for instance, tray 1/first high-volume stacking tray 1054) (Step S204).

Incidentally, it is applicable that the paper sheet having the confirmation image of the job output (for instance, page “j” of job “j”) is automatically ejected onto the first high-volume stacking tray 1054 disposed at such a position that the upper surface of the tray can be seen by the operator's visual observation. Further, it is also applicable that the paper ejecting tray employed for the normal job output conducted in Step S111 and Step S120, and the other paper ejecting tray employed for the job output for confirmation image conducted in Step S116 are switched to a different paper stacking tray.

Reading out the information of the job suspension aye-or-nay selection stored in Step S109, it is determined whether or not the job should be suspended (Step S205).

When determining that the job should be suspended (Step S205: Yes), the output operation of the job image is suspended (Step S206).

Incidentally, it is also applicable that the output operation of the job image in regard to the currently implemented job is made to be continued until the whole job is completed, and then, made to be suspended.

When determining that the job should not be suspended (Step S205: No), the process jumps to Step S208, in order to continue the successive output operation of the job image.

In Step S207-Step S209, the correction processing is conducted in the same manner as conducted in S119-Step S121. When determining that absence of the correction is stored (Step S207, Step S209: No), the process jumps to Step S210, in order to wait the image forming activating operation (Step S210).

When the activating command of the image forming operation turns ON, the image outputting and ejecting operations based on the job image information are resumed (Step S211).

The job image information stored in Step S101 are read out, in order to determine whether or not the job concerned is completed (Step S212).

When the job concerned is not completed (Step S212: No), it is determined that the reading job is not completed, and the process jumps to Step S111 (FIG. 17: X) to output the uncompleted job.

When the job concerned is completed (Step S212: Yes), it is determined that the reading job is completed. Then, this program is finalized, and the process jumps to, for instance, a main routine (not shown in the drawings).

Further, when determining that it is not every predetermined number of sheets (Step S201: No), it is determined that the confirmation image is instantaneously outputted at the designated time. Then, the process jumps to Step S301 (refer to FIG. 24), so as to read out the job image information corresponding to the job number (for instance, job “j”) and the page number (for instance, page “j”) stored in the RAM M10.

An inputting operation of the confirmation image instantaneous output instruction is waited (Step S302).

When the confirmation image instantaneous output instruction is inputted, the image is outputted onto the paper sheet, based on the job image information read out in Step S301, and the paper sheet is ejected onto the paper stacking tray selected by using the paper ejecting tray selecting screen in Step S104 (for instance, tray 1/first high-volume stacking tray 1054) (Step S303).

Incidentally, it is applicable that the paper sheet having the confirmation image of the job output (for instance, page “j” of job “j”) is automatically ejected onto the first high-volume stacking tray 1054 disposed at such a position that the upper surface of the tray can be seen by the operator's visual observation. Further, it is also applicable that the paper ejecting tray employed for the normal job output conducted in Step S111 and Step S120, and the other paper ejecting tray employed for the job output for confirmation image conducted in Step S116 are switched to a different paper stacking tray.

Reading out the information of the job suspension aye-or-nay selection stored in Step S109, it is determined whether or not the job should be suspended (Step S304).

When determining that the job should be suspended (Step S304: Yes), the output operation of the job image is suspended (Step S305).

Incidentally, it is also applicable that the output operation of the job image in regard to the currently implemented job is made to be continued until the whole job is completed, and then, made to be suspended.

When determining that the job should not be suspended (Step S304: No), the process jumps to Step S307, in order to continue the successive output operation of the job image.

In Step S306-Step S308, the correction processing is conducted in the same manner as conducted in S119-Step S121. When determining that absence of the correction is stored. (Step S306, Step S308: No), the process jumps to Step S309, in order to wait the image forming activating operation (Step S309).

When the activating command of the image forming operation turns ON, the image outputting and ejecting operations based on the job image information are resumed (Step S310).

The job image information stored in Step S101 are read out, in order to determine whether or not the job concerned is completed (Step S311).

When the job concerned is not completed (Step S311: No), it is determined that the reading job is not completed, and the process jumps to Step S111 (FIG. 17: X) to output the uncompleted job.

When the job concerned is completed (Step S311: Yes), it is determined that the reading job is completed. Then, this program is finalized, and the process jumps to, for instance, a main routine (not shown in the drawings).

Next, the case that the job image information is not selected (Step S105: No) and a test chart image is outputted as the confirmation image will be detailed in the following.

A density correction patch image, a gradation confirmation density chart image, etc. could be cited as the test chart image. A gradation confirmation density chart 2041 and a job page number 2042 (for instance, page 1234) of the job at the time when the test chart is to be outputted, are displayed on a density chart screen 1204 being an example of the test chart image.

Since the operations to be conducted in Step S401 and the following steps, are substantially the same as those to be conducted in Step S106 through Step S308, except that the image to be outputted as the confirmation image is the job image in Step S101 through Step S308, while the image to be outputted as the confirmation image is the test chart image in Step S401 and the following steps, operations, which are extremely different from those shown in Step S401 through Step S417 being equivalent to Step S106 through Step S308, will be detailed in the following.

The flowchart for outputting the test chart is constituted by the steps of Step S401 through Step S417, the similar flowchart including Step S201 through Step S209 as shown in FIG. 23 and the similar flowchart including Step S301 through Step S308 as shown in FIG. 24.

When the job image information is not selected (Step S105: No), namely, when the test chart is selected, the test chart image information are read from the ROM M20 (Step S401).

When a plurality of test charts exist in Step S401 through Step S403 shown in FIG. 25, arbitral one of the plurality of test charts is designated (for instance, the density test chart shown in FIG. 22). Further, the designated test chart is outputted in Step S411 and Step S412.

Further, in the steps equivalent to Step S203 and Step S204 shown in FIG. 23, the designated test chart is read out and outputted.

Further, in the steps equivalent to Step S301 through Step S303 shown in FIG. 24, the designated test chart is read out and outputted.

After the output operation of the job image is disabled in Step S414, it is determined in Step S103 whether or not presence of the correction is stored (Step S415).

When determining that presence of the correction is stored (Step S415: Yes), the correction processing is conducted (Step S416).

In the correction processing to be conducted in Step S415, a conventional correcting operation with respect to at least one of an image density property and a gradation characteristic (for instance, the correction in regard to the image density property and the gradation characteristic set forth in Tokkaihei 5-14728) is automatically conducted. In other words, the detecting operation with respect to the image density property and the gradation characteristic of the test chart is automatically conducted, so as to conduct the correction processing with respect to the image density property and the gradation characteristic based on the detected values.

When determining that absence of the correction is stored (Step S415: No), the process jumps to Step S417, in order to wait the implementation of the image forming activating operation (Step S417).

Further, when determining that absence of the correction is stored (Step S415: No), a colored paper picked up from the paper feeding tray designated by the operator (for instance, the paper feeding tray for accommodating the colored papers) is conveyed and stacked onto the uppermost surface of the currently stacked papers as a making paper indicating before and after of the correcting timing and serving as a bookmark. In this case, when the paper feeding apparatus 1009 is coupled to the image forming apparatus 1001, the colored paper is fed from a predetermined tray in the paper feeding apparatus 1009 by communicating with each other.

The image forming system, in which the paper feeding apparatus, the image forming apparatus and the post-processing apparatus are coupled to each other, will be detailed in the following.

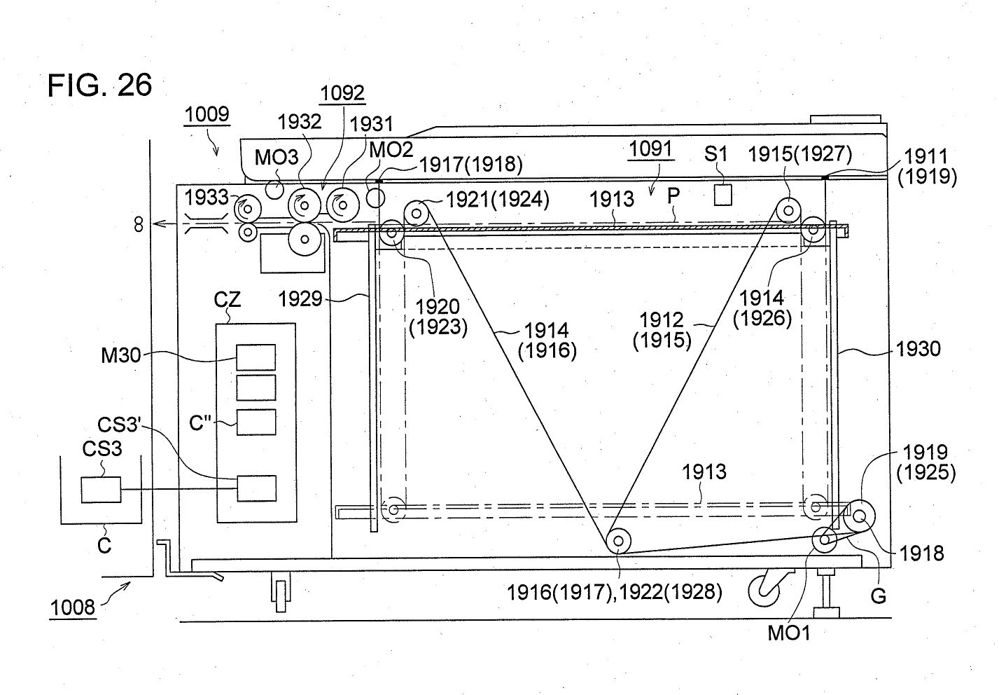

FIG. 26 shows an explanatory schematic diagram of the paper feeding apparatus.

FIG. 26 shows a cross sectional schematic diagram of an example of the paper feeding apparatus to be coupled to the image forming apparatus. The paper feeding apparatus will be detailed in the following.

As shown in FIG. 26, a paper stacking tray 1913, which moves up and down in a vertical direction of the drawing while accommodating paper sheets P on it, is elevated near the uppermost position. Further, the paper sheet P is accommodated on the upper surface of the paper stacking tray 1913.

Initially, the movement of the paper stacking tray 1913 will be detailed. End portions of elevation wires 1914, 1912, 1916, 1915 are hooked to hooking sections 1917, 1911, 1918, 1919, respectively, and other end portions of them are fixed to an elevation driving shaft 1918. Further, running blocks 1921, 1924, 1914, 1926 are suspended by the elevation wires 1914, 1912, 1916, 1915, and the paper stacking tray 1913 is fixed on the running blocks 1921, 1924, 1914, 1926.

With this mechanical configuration, the paper stacking tray 1913 can be moved up and down by rotating the elevation driving shaft 1918 in normal and reverse directions.

Concretely speaking, in each of obverse and reverse sides of the paper, the elevation wire 1914 (1916), one end of which is hooked to the hooking section 1917 (1918), is threaded on the running blocks 1920 (1923), a pulley 1921 (1924), a pulley 1916 (1917), which are supported by the paper feeding apparatus proper, and further, is winded around a pulley 1919 (1925) disposed at the other end portion of the elevation driving shaft 1918 and fixed to it. Further, in each of obverse and reverse sides of the paper, the elevation wire 1912 (1915), one end of which is hooked to the hooking section 1911 (1919), is threaded on the running blocks 1914 (1926), a pulley 1921 (1924), a pulley 1916 (1917), which are supported by the paper feeding apparatus proper, and further, is winded around a pulley 1919 disposed at the other end portion of the elevation driving shaft 1918 and fixed to it.

Further, the elevation driving shaft 1918 supported by the paper feeding apparatus proper is driven by the driving section including a motor MO1 and a driving force transmission system G. The elevation driving shaft 1918 is driven to rotate in either a normal direction or a reverse direction in response to the rotating action of the motor MO1 in either a normal direction or a reverse direction through the driving force transmission system G including a gear train.

The elevation driving shaft 1918 is driven to rotate by the driving action of the motor MO1 through the driving force transmission system G including a gear train. According to the rotating action of the elevation driving shaft 1918, the pulley 1919 fixed on the elevation driving shaft 1918 winds up the elevation wires 1914, 1912, 1916, 1915.

The elevation wires 1914, 1912, 1916, 1915, one end portions of which are fixed to the hooking sections 1917, 1911, 1918, 1919 and which are threaded on the pulleys 1921, 1924, 1922, 928 are winded or unwound around the elevation driving shaft 1918 so as to elevate or lower the intermediate running blocks 1920, 1923, 1914, 1926. A moving amount of each of the running blocks is equal to ½ of that of each of the elevation wires. The paper stacking tray 1913, whose four corners are fixed on the running blocks 1920, 1923, 1914, 1926, elevates or descends at ½ of the moving amount and the velocity of each of the elevation wires.

The paper stacking tray 1913 is guided by the guiding grooves 1929, 1930 so as to be movable in a vertical direction.

Incidentally, the alternate long and short lines shown in FIG. 26 indicate the paper stacking tray 1913 descending near the lower limit position.

A paper sensor S1 detects the uppermost surface of the papers accommodated on the paper stacking tray 1913. Based on the detected result of the paper sensor S1, a paper feeding control section CZ controls the motor MO1 so that the position of the uppermost surface of the papers coincides with the lower surface of a separation roller 1931.

The paper feeding control section CZ rotates a motor MO2 at a predetermined timing in a direction indicated by the arrow, so that the separation roller 1931 picks up the uppermost paper sheet P from the papers stacked on the paper stacking tray 1913.

Then, the paper feeding control section CZ controls the driving action of a motor MO3 to rotate intermediate rollers 1932 and ejecting rollers 1933 in directions respectively indicated by the arrows, so that the paper sheet P picked up by the separation roller 1931 is ejected from an ejecting outlet 1934 and fed into the image forming apparatus 1001 disposed downstream from the paper feeding apparatus 1009.

Incidentally, the paper feeding control section CZ of the paper feeding apparatus 1009 is provided with a controlling section C″ including the CPU, etc., a communication section CS3′ of the paper-feeding apparatus for communicating with the image forming apparatus 1001, a ROM M30 for storing programs in regard to the paper feeding operation, etc.

Further, the communication section CS3′ of the paper-feeding apparatus is coupled to the paper-feeding apparatus communication section CS3 of the image forming apparatus 1001. The paper feeding control section CZ receives a paper conveyance command sent from the image forming apparatus 1001 through the paper-feeding apparatus communication section CS3 and the communication section CS3′. Based on the paper conveyance command, the paper feeding control section CZ controls the aforementioned sections so as to pick up the paper sheet P one by one and feed it to the image forming apparatus 1001.

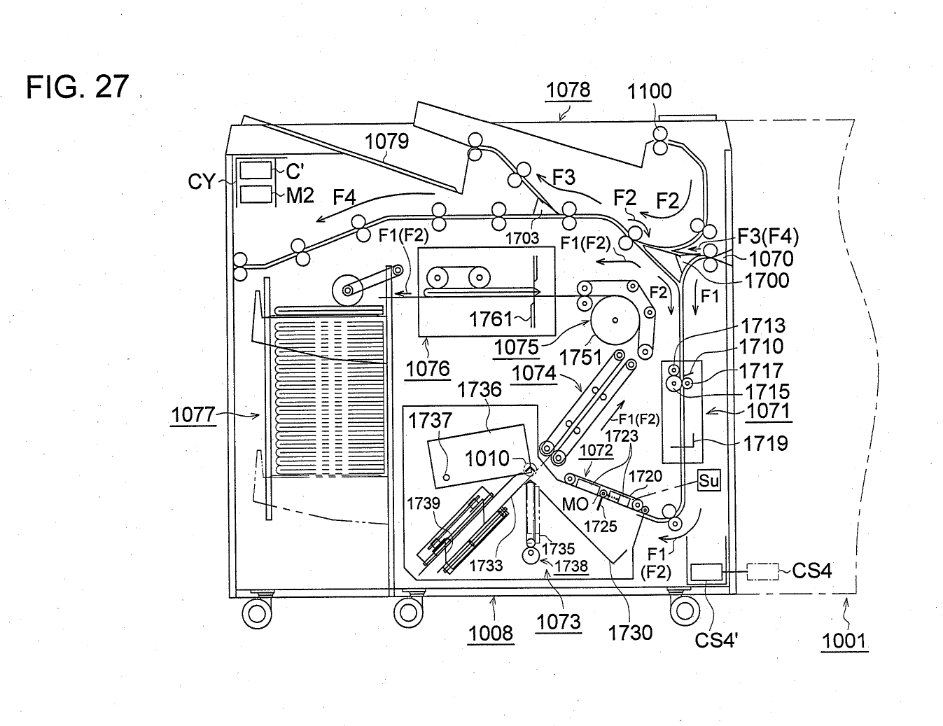

FIG. 27 shows an explanatory block diagram of the post-processing apparatus.

FIG. 27 shows a cross sectional schematic diagram of an example of the post-processing apparatus to be coupled to the image forming apparatus. The post-processing apparatus 1008 will be detailed in the following.

The post-processing apparatus 1008 is provided with: a paper inlet opening 1070 for inputting the paper sheet P ejected from the image forming apparatus 1001 by the paper ejecting rollers 1053; a center folding section 1071 (hereinafter, also referred to as a center folding unit 1071) for center-folding the papers set on a paper conveyance path; a first conveyance section 1072 (hereinafter, also referred to as a first conveyance unit 1072) employing an air absorbing method for conveying the paper sheet; a saddle stitch stapling section 1073 for applying, for instance, a staple processing to the paper sheets; a second conveyance section 1074 including a pair of belts for conveying the paper sheet; a third conveyance section 1075 including rollers and belt for conveying the paper sheet; a cutting section 1076 for cutting the paper sheets by means of a cutter; a paper stacking section 1077 for stacking the paper sheets; a cover sheet feeder 1078 for stacking and feeding cover sheets; a tray 1079 for stacking the paper sheets and disposed at such a position that the upper surface of the tray can be seen by the operator's visual observation from the upper side of the post-processing apparatus 1008; and a post-processing apparatus controlling section CY for controlling the abovementioned sections and units.

The arrows of F1, F2, F3 and F4 indicate four conveyance paths of the paper sheet. Based on the saddle stitch stapling command, the paper sheets are conveyed through a first conveyance path F1. A cover sheet for a bunch of the paper sheets conveyed through the first conveyance path F1 and stacked onto the saddle stitch stapling section 1073 is conveyed through a second conveyance path F2. The paper sheets for which the saddle stitch stapling is not necessary are conveyed through a third conveyance path F3. The paper sheets, for which a post-processing to be applied in another post-processing apparatus integrally coupled to the post-processing apparatus 1008 is necessary, are conveyed through a fourth conveyance path F4. Each of the conveyance paths F1 through F4 is provided with a large number of pares of conveyance rollers (without reference numbers).

Further, numeral 1700 indicates a first conveyance path switching section to selectively open either the first conveyance path F1 or the third conveyance path F3 (make it usable state), while numeral 1703 indicates a second conveyance path switching section' to selectively open either the first conveyance path F3 or the third conveyance path F4 (make it usable state). The first and second conveyance path switching sections 1700, 1703 are controlled corresponding to the content of the operation command.

Still further, the center folding unit 1071 equipped on the first conveyance path F1 is provided with: a push-insertion member 1710, made of a thin plate or a knife-shaped plate member, for push-inserting the paper sheet in a direction orthogonal to the conveyance direction of the paper sheet (in the present embodiment, the horizontal direction); an upper roller 1713 and a lower roller 1715 for press-holding the paper sheet, push-inserted by the push-insertion member 1710, between them; a conveyance roller 1717 that rotates while press-contacting the lower roller 1715 so as to convey the paper sheet in a normal direction (a conveyance direction along the conveyance path, in this case, a direction from an upper position toward a lower position); and a stopper 1719 that is disposed downstream from the group of rollers mentioned in the above and detachable from the conveyance path.

Still further, with respect to the size of the paper sheet employed in the conveyance direction, the stopper 1719 is disposed at such a position that corresponds to a half of the length of the paper sheet from the nip position between the upper roller 1713 and lower roller 1715 in the height direction, and, when the leading edge of the paper sheet inputted from the paper inlet opening 1070 arrives at the stopper 1719, the rotations of the group of rollers in the normal direction are stopped.

Successively, the paper sheet is press-inserted into the nip between the upper roller 1713 and the lower roller 1715 by the push-insertion member 1710 so as to form a fold line in the direction orthogonal to the conveyance direction, and then, the paper sheet is conveyed out toward the saddle stitch stapling section 1073 by again rotating the group of rollers in the normal direction.

The first conveyance section 1072 is provided with a rotatable belt 1720 having many holes on it, and a suction box 1723 disposed inside the rotatable belt 1720 and coupled to a suction unit Su through a duct.

Numeral 1725 indicates a rotatable separation member made of a wire material, such as a metal wire, etc., for butting the leading edge of the paper sheet, conveyed in a state of being absorbed onto the lower surface of the rotatable belt 1720, from the inside of the belt (from the upper side in the drawing) so as to separate the paper sheet from the rotatable belt 1720. A motor MO drives the rotatable separation member 1725.

The saddle stitch stapling section 1073 is provided with a stacking section for stacking the paper sheet conveyed through the first conveyance section 1072. The stacking section is constituted by a first guide member 1730 (serving as paper receiving section) disposed upstream and a second guide member 1733 (serving as paper receiving section) disposed downstream as main constituents.

Each of the first guide member 1730 and the second guide member 1733 is made of a plate member disposed with an inclination to a perpendicular plane of 45 degrees. The combined form of them is shaped in a chevron, and the top portion formed by the edges of both guide members has a gap.

Further, a center portion divided in a depth direction of the second guide member 1733 is configured so as to reciprocally move within a range of predetermined distance slantwise from the current position shown in FIG. 27 to a right upper position.

This is because, the leading edge is made to enter into the fold line of the bunch of paper sheets after the saddle stitch stapling is completed, and the bunch of paper sheets is push-inserted into a gap of the belts of the second conveyance section 1074 while forming in a folio shaped booklet.

A staple receiving section 1735 is disposed at a center position between the first guide member 1730 and the second guide member 1733 in such a manner that its height position is fixed and it is movable in a depth direction (a direction between obverse and reverse sides of the drawing). Further, a part of the top portion of the staple receiving section 1735 is positioned at the gap of the top portion formed by the edges of both guide members.

Stapling devices 1736 are arranged at intervals of predetermined distance in the upper space relative to the staple receiving section 1735 in such a manner that it is movable in a depth direction and capable of swinging around a shaft 1737.

A stapler constituted by the stapling devices 1736 and the staple receiving section 1735 has a capability of stapling a bunch of 100 paper sheets. In the present embodiment, two of the staplers are arranged with an appropriate interval in a depth direction of the drawing.

The positioning operation of the paper sheet is achieved by employing the first guide member 1730, the second guide member 1733 and a stopper 1739 for positioning the leading edge of the paper sheet. A truing member 1738 is employed for truing the fold line of the paper sheet, and, by activating the stapling devices 1736 and the staple receiving section 1735, a booklet having 100 two-folded paper sheets can be obtained.

Other than the above, the post-processing apparatus 1008 is so constituted that a curling correction processing, a punch processing and a sort processing can be also conducted by employing the conventional configurations (not shown in the drawings).

The bunch of paper sheets, the saddle stitch stapling for which is completed by employing the configuration mentioned in the foregoing, is pushed up in a right upper direction by a part of the second guide member 1733, and then, transferred to the second conveyance section 1074 while being gradually formed in a booklet shape. Successively, by the actions of the second conveyance section 1074 and the third conveyance section 1075, the booklet-shaped bunch of paper sheets is changed in its conveyance direction and tightly two-folded. Then, the end of the booklet is cut by a cutter 1761 in the cutting section 1076 and ejected onto the paper stacking section 1077.

The paper stacking section 1077 descends according as the stacking amount of the paper sheets increases, so as to make it possible to stack a predetermined amount of the paper sheets on it.

Further, the post-processing apparatus controlling section CY is provided with the ROM M20 storing the programs in regard to the operations for controlling the finish processing and communication controlling operation, etc., the post-processing apparatus communication section CS4′ for communicating with the image forming apparatus 1001, a controlling section C′ including a CPU, etc., in order to controlling the units and sections mentioned in the foregoing.

The programs necessary for the operations for controlling the finish processing, the programs necessary for the operation combined with the image forming apparatus 1001, etc. are stored in advance in the ROM M20.

The post-processing apparatus communication section CS4′ of the post-processing apparatus 1008 is coupled to the post-processing apparatus communication section CS4, so that the confirmation image paper information of whether or not the paper sheet to be fed relates to the confirmation image (whether or not relates to the normal job) and the job information are transmitted from the controlling section C of the image forming apparatus 1001 to the post-processing apparatus controlling section CY through the post-processing apparatus communication section CS4 and the post-processing apparatus communication section CS4′. Then, the confirmation image paper information and the job information are inputted into the post-processing apparatus controlling section CY.

When receiving the confirmation image paper information indicating that the paper sheet to be fed into the post-processing apparatus 1008 is the confirmation image paper, the post-processing apparatus controlling section CY activates the second conveyance path switching section 1703 to open the third conveyance path F3, so as to eject the confirmation image paper conveyed onto the tray 1079, the upper surface of which can be seen by the operator's visual observation.

Further, the post-processing apparatus controlling section CY conducts controlling operations so that the paper sheet is conveyed into the necessary conveyance path corresponding to the job information, the finish processing is conducted corresponding to the job information as aforementioned, and the paper sheets of the normal job image are ejected and stacked onto the paper stacking section 1077 on which a large amount of paper sheets can be stacked.

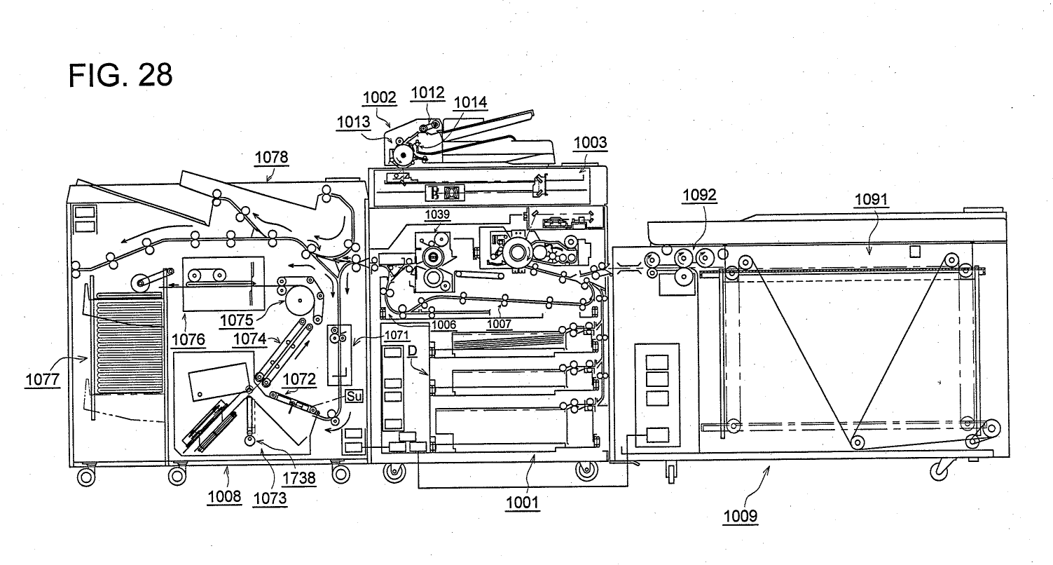

FIG. 28 shows an explanatory schematic diagram of the image forming system embodied in the present invention.

In the image forming system shown in FIG. 28, the post-processing apparatus 1008 and the paper feeding apparatus 1009 are respectively coupled to the image forming apparatus 1001, so that the image forming apparatus 1001 forms the job image or the confirmation image onto the paper sheet P fed from the paper feeding apparatus 1009, and then, the paper sheet P is stacked onto the post-processing apparatus 1008.

The paper feeding apparatus 1009, the image forming apparatus 1001 and the post-processing apparatus 1008, each of which is configured as aforementioned, conduct the sequential and cooperative operations as a whole system.

Incidentally, with respect to each of the paper feeding apparatus 1009, the image forming apparatus 1001 and the post-processing apparatus 1008, both the individual and cooperative operations have been described in the foregoing. Accordingly, the explanations for the image forming system as a whole will be omitted in the following.

It is also applicable that the image forming system comprises a plurality of paper feeding apparatuses and a plurality of post-processing apparatus 1008 for conducting systematic operations as needed.

Although the monochrome image forming apparatus is exemplified in the fourth embodiment, it is needless to say that the present invention can be also applied to the color image forming apparatus in the same way as aforementioned.

According to the fourth embodiment of the present invention, the following effects can be attained.
(1) Since the image forming apparatus is provided with the confirmation-image outputting time designating section for designating a time for outputting the confirmation image and a controlling section for outputting the confirmation image at the time designated by the confirmation-image outputting time designating section during the output operation of the job images, it becomes possible to output the confirmation images during the image forming operation with respect to the job. Accordingly, it becomes possible to provide an image forming apparatus, which makes it possible to complete the urgent image-forming job in time even if the operation for outputting the confirmation images during the implementation of the image forming job is requested.
(2) Since any one of the job image and the test chart image can be switch-ably outputted as the confirmation images, it becomes possible to confirm various kinds of factors, such as the position of the image, the quality of the image, etc.
(3) Since the outputting time can be designated as any one of every predetermined number of copies, every predetermined number of sheets and an arbitrarily determined timing, it becomes possible to automatically conduct the outputting operation at various kinds of timings.
(4) Since a specific image among the job images of plural pages is selected as the confirmation images, it becomes possible to confirm various kinds of factors, such as the position of the image, the quality of the image, etc.
(5) Since the image forming apparatus is provided with a plurality of trays for ejecting the paper sheets of the normal job, and the paper sheets bearing the confirmation images are stacked on one of the plurality of trays, while the paper sheets of the normal job are stacked on the other one of said plurality of trays, it becomes possible to omit the exclusive ejecting tray for the confirmation images, resulting in simplification of the image forming apparatus.
(6) Since the paper sheets bearing the confirmation images are ejected onto the ejecting tray, which is disposed at such a position that an upper surface of said ejecting tray can be seen by an operator's visual observation, it becomes possible for the operator to check the confirmation images without picking out them from the tray, resulting in an improvement of the productivity.
(7) Since the operation for outputting job images can be suspended when the confirmation image is outputted during the operation of outputting the job images, it becomes possible to check the confirmation images ejected onto the tray for a necessary time interval, and when a certain problem is recognized by checking the confirmation images, it becomes possible for the operator to cope with the problem during the suspension interval.
(8) Since at least one of the image-quality density and the gradation characteristic is correctable and the confirmation image based on the correcting operation can be outputted after the image forming job is suspended and before the re-activating command is inputted, it becomes possible for the operator to see the correction result by an operator's visual observation and to cope with the problem during the suspension interval.
(9) Since a page number with respect to the job can be attached to the confirmation image, it becomes possible to confirm what confirmation images were outputted at what timing during the job concerned even at a later time, resulting in an easiness of improving the problem during the suspension interval and after that.
(10) Since a paper sheet (for instance, a colored paper sheet) is fed form the designated paper feeding tray at the time of resuming the job from the division of the suspended job, it becomes possible to clarify the position of the correction, resulting in an easiness of improving the problem during the suspension interval and after that.
(11) Since the image forming apparatus, which is provided with the outputting time designating section for designating an outputting time of the confirmation images and the controller for controlling the image forming section so as to output the confirmation image at the outputting time designated by the outputting time designating section during the implementation of the outputting operation of the job images, and the post-processing apparatus, which is capable of ejecting paper sheets onto the paper ejecting tray disposed at such a position that an upper surface of said ejecting tray can be seen by an operator's visual observation at the time of conveying the confirmation images, are coupled to each other, it becomes possible to provide an image forming apparatus, which makes it possible to complete the urgent image-forming job in time even if the operation for outputting the confirmation images during the implementation of the image forming job is requested.

While the preferred embodiments of the present invention have been described using specific term, such description is for illustrative purpose only, and it is to be understood that changes and variations may be made without departing from the spirit and scope of the appended claims.

The present invention can be applied to not only copy machine but also printer which prints based on various data.

1.-9. (canceled)

10. The An image forming system of, comprising:
an image forming section to respectively form images on recording materials;
a stacking section to stack recorded materials continuously ejected from the image forming section after the images are respectively formed on the recording materials;
an instruction inputting section from which instruction information is inputted with respect to a confirmation-image outputting operation for confirming a finished status of the images formed on the recorded materials;
an ejecting section to stack a part of the recorded materials ejected from the image forming section; and
a controlling section to conduct controlling operations in response to the instruction information, inputted from the instruction inputting section during an implementation of an image forming job including an operation for stacking the recorded materials ejected from the image forming section, in order to eject the part of the recorded materials onto the ejecting section;
wherein the instruction information includes an instruction for instructing output conditions with respect to the confirmation-image outputting operation;
wherein, when the output conditions, inputted from the instruction inputting section, are fulfilled during the implementation of the image forming job, the controlling section conducts the controlling operations to eject a part of the recorded materials onto the ejecting section;
wherein an instruction of whether or not the confirmation-image outputting operation is to be conducted when an environmental deviation amount in the image forming system exceeds a predetermined deviation amount during the implementation of the image forming job, can be inputted from the instruction inputting section as the output conditions with respect to the confirmation-image outputting operation; and
wherein, in a case that the instruction, indicating that the confirmation-image outputting operation is to be conducted when the environmental deviation amount in the image forming system exceeds the predetermined deviation amount during the implementation of the image forming job, is inputted from the instruction inputting section, the controlling section conducts the controlling operations to eject the part of the recorded materials onto the ejecting section when the environmental deviation amount in the image forming system exceeds the predetermined deviation amount during the implementation of the image forming job.

11. The image forming system of claim 10,
wherein the controlling section conducts controlling operations, so as to suspend the image forming job currently implemented, just after ejecting the part of the recorded materials onto the ejecting section.

12. The image forming system of claim 11,
wherein the instruction information, inputted from the instruction inputting section, includes an instruction of whether or not the image forming job currently implemented is to be suspended just after ejecting the part of the recorded materials to be ejected onto the ejecting section; and
wherein, when the instruction, indicating that the image forming job currently implemented is to be suspended just after ejecting the part of the recorded materials onto the ejecting section, is inputted from the instruction inputting section, the controlling section conducts controlling operations to suspend the image forming job currently implemented, just after the part of the recorded materials are ejected onto the ejecting section.

13. The image forming system of claim 12, further comprising:
a setting section to set finish conditions of the images in the image forming job; and
wherein the controlling section accepts the finish conditions set by the setting section, after suspending the image forming job currently implemented.

14. The image forming system of claim 13,
wherein, when the finish conditions are changed to new finish conditions in the setting section, the controlling section controls the image forming section so as to respectively form the images onto the recording materials under the new finish conditions, and conducts controlling operations to eject the part of the recorded materials onto the ejecting section.

15. The image forming system of claim 11, further comprising:
a job resumption instructing section to input an instruction for resuming the image forming job previously suspended by the controlling section; and
wherein, when the instruction for resuming the image forming job is inputted from the job resumption instructing section, the controlling section conducts controlling operations to resume the image forming job previously suspended and to eject the part of the recorded materials, onto the ejecting section.

16.-33. (canceled)
